(19) United States
(12) Patent Application Publication
(10) Pub. No.: US 2020/0206822 A1
(43) Pub. Date: Jul. 2, 2020

(54) Multi-Spindle Lathe

(71) Applicants: Dirk Prust, Esslingen (DE); Karl-Heinz Schumacher, Reutlingen (DE)

(72) Inventors: Dirk Prust, Esslingen (DE); Karl-Heinz Schumacher, Reutlingen (DE)

(21) Appl. No.: 16/815,817

(22) Filed: Mar. 11, 2020

Related U.S. Application Data
(63) Continuation of application No. PCT/EP2018/059681, filed on Apr. 16, 2018.

(30) Foreign Application Priority Data
Sep. 14, 2017 (DE) 10 2017 121 295.7

(51) Int. Cl. B23B 13/04; B23Q 39/04; B23B 13/12

(52) U.S. Cl. CPC B23B 13/04; B23Q 2039/008; B23B 13/123; B23Q 39/044

(57) ABSTRACT

The invention relates to a multi-spindle lathe comprising a machine frame, a spindle drum mounted on the machine frame so as to be rotatable about a spindle drum axis, workpiece spindles each arranged in a spindle position on the spindle drum and each mounted to be rotatable relative to the spindle drum about a workpiece spindle axis, said workpiece spindles being positionable by rotating the spindle drum about the spindle drum axis into different spindle stations which are arranged statically relative to the machine frame, for machining workpieces arranged in said workpiece spindles, wherein associated with each workpiece spindle is a workpiece guide bushing for guidance of a material bar held in the workpiece spindle for long turning, said material bar being arranged movably relative to the respective workpiece spindle in a direction parallel to the workpiece spindle axis.

### CROSS-REFERENCE TO RELATED PATENT APPLICATIONS

This application is a continuation of International application number PCT/EP2018/059681 filed on Apr. 16, 2018.

This patent application claims the benefit of International application No. PCT/EP2018/059681 of Apr. 16, 2018 and German application No. 10 2017 121 295.7 of Sep. 14, 2017, the teachings and disclosure of which are hereby incorporated in their entirety by reference thereto.

### BACKGROUND OF THE INVENTION

The invention relates to a multi-spindle lathe, comprising a machine frame, a spindle drum mounted on the machine frame so as to be rotatable about a spindle drum axis, workpiece spindle units each arranged in a spindle position on the spindle drum and each mounted to be rotatable relative to the spindle drum about a workpiece spindle axis, said workpiece spindle units being positionable by rotating the spindle drum about the spindle drum axis into different spindle positions which are arranged statically relative to the machine frame, for machining workpieces arranged in said workpiece spindles.

A multi-spindle lathe of this type is a classic multi-spindle lathe.

In such multi-spindle lathes, however, the problem exists of being able also to machine elongate workpieces in the easiest possible manner without any great constructional complexity being required.

### SUMMARY OF THE INVENTION

This problem is solved in a multi-spindle lathe of the type mentioned in the introduction according to the invention in that associated with each workpiece spindle is a workpiece guide bushing for guidance of a material bar held in the workpiece spindle for long turning, said material bar being arranged movably relative to the respective workpiece spindle in a direction parallel to the workpiece spindle axis thereof.

The advantage of the solution according to the invention is to be found therein that a conventional multi-spindle lathe can, in a simple way, be configured so that therewith, by means of the workpiece guide bushing, a long turning with material bars is possible.

In particular, it is possible by means of the displaceability of the workpiece guide bushing that the workpiece spindles can be arranged non-displaceably relative to the spindle drum in the direction of the workpiece spindle axis, so that there is no necessity for having to move the workpiece spindles relative to the spindle drum itself for long turning, and thus, in particular, a long turning can be carried out using the Offenbach system.

With regard to the arrangement of the workpiece guide bushing, no further details have so far been given.

It is preferably provided that the workpiece guide bushing is guided by means of a foot member on a carrier unit, wherein the carrier unit is arranged, in particular, in the working area.

In order to be able to implement an exact guidance of the workpiece guide bushing during its movement in the direction parallel to the workpiece spindle axis, for each workpiece guide bushing, a linear guide is preferably provided which movably guides the workpiece guide bushing in a direction parallel to the workpiece spindle axis.

The linear guide could be arranged, for example, in relation to the spindle drum axis lying radially externally on the workpiece guide bushings.

However, it is particularly favourable if the linear guide is arranged on a side of the respective workpiece guide bushing facing toward the spindle drum axis.

With regard to the construction of the linear guide, no details have so far been given in the context of the previously described solution.

An advantageous solution thus provides that each linear guide comprises at least one longitudinal guide and a carriage member which is displaceably guided on the respective at least one longitudinal guide and carries the workpiece guide bushing.

It is thereby particularly favourable if the carriage member is part of the foot member which holds the workpiece guide bushing.

It is conceivable, in principle, to provide a carrier unit for each of the linear guides.

For reasons of constructional and space efficiency, it is particularly favourable, however, if the linear guides of all the workpiece guide bushings are arranged on a common carrier unit.

With regard to the arrangement of the carrier unit, again no further details have so far been given.

It is thus particularly favourable if the carrier unit is arranged in a working area of the machine tool extending from a front side of the spindle drum.

It is thereby preferably provided that the carrier unit extends in a direction parallel to the spindle drum axis.

Preferably, the carrier unit is configured symmetrically to the spindle drum axis according to the number of workpiece spindles.

This means that, for example, with six workpiece spindles of the spindle drum, the carrier unit has a six-fold symmetry to the spindle drum axis and, for example, accordingly carries six linear guides for the six workpiece guide bushings.

In order to sustain the association of the workpiece guide bushings with the material bars held in the workpiece spindles even when indexing the spindle drum, it is preferably provided that the carrier unit is rotatable about the spindle drum axis and synchronously with the spindle drum.

It is thereby ensured that the association of the individual workpiece guide bushings with the individual workpiece spindles is sustained even on rotation of the spindle drum.

This could be achieved by means of a drive provided specifically for the carrier unit.

In the simplest case, it is provided that the carrier unit is coupled to the spindle drum in a rotationally fixed manner.

A solution of particularly suitable construction provides that the carrier unit is mounted on an end face of the spindle drum and thus, in particular, is also carried by the spindle drum.

With this solution, a precise positioning of the workpiece guide bushings relative to the workpiece spindles arranged in the spindle drum is realisable in a simple manner during the whole of the machining process.

Preferably, it is provided in this case that the carrier unit encroaches in the working area starting from the end face of the spindle drum.

A particularly suitable solution provides that, proceeding from, and in extension of, the carrier unit, a duct extends further through the working area and, in particular, emerges from the working area on a side opposite the end face of the spindle drum, so that by means of this duct, lines can easily be guided to the individual workpiece guide bushings.

With regard to the embodiment of the workpiece guide bushings, no detailed information has so far been given in the context of the description above of the solution according to the invention.

An advantageous solution thus provides that each of the workpiece guide bushings comprises a guide sleeve guiding the material bar coaxially with the workpiece spindle axis, said guide sleeve being freely rotatable relative to an external housing of the respective workpiece guide bushing.

This means that by means of such a freely rotatable guide sleeve guiding and, in particular, supporting the material bar, an advantageous supporting of the material bar during its machining is realisable.

It is particularly favourable if the workpiece guide bushing acts by means of the guide sleeve with a radial force on the material bar, wherein the radial force is preferably adjustable with regard to the level of radial force.

It is particularly favourable if guide jaws of the workpiece guide bushing which are placeable on the material bar are arranged in the guide sleeve which is rotatable coaxially with the workpiece spindle axis and thus permit a corresponding support and guidance of the material bar.

In order to be able to pre-set the precision of the guidance accordingly, it is preferably provided that each workpiece guide bushing comprises guide jaws that are movable radially relative to a guidance axis of the guide sleeve axis of the movable guide jaws.

In particular, it is favourable if each workpiece guide bushing acts by means of the guide jaws with the radial force on the material bar.

Thereby, the radial force can be applied and adjusted in a particularly favourable manner.

A particularly simple solution provides that the guide jaws are acted upon by a spring in the direction of their position abutting the material bar and guiding it with a radial force.

In principle, such guide jaws can be mechanically or electrically adjustable.

A particularly simple solution provides that the guide jaws are radially adjustable by means of an adjusting unit or control unit by a medium in order thereby to be able to set, firstly, the precision of the guidance of the material bar and, secondly, the smoothness of the movement relative to the material bar.

The medium can thereby serve to counteract a radial force in the direction of the material bar generated by an elastic element, in order to release the guidance.

Preferably, the medium serves for generating the radial force with which the guide jaws act upon the material bar.

In particular, in order to be able to realise the adjustability of the guidance of the material bar, it is preferably provided that a medium feed to each workpiece guide bushing takes place via the foot member of the respective workpiece guide bushing.

In order to be able to realise such a control of the respective workpiece guide bushing, it is preferably provided that a line for controlling the respective workpiece guide bushings is routed via the respective foot member.

It is hereby favourable, in particular, if a hydraulic feed takes place, for example, via the carriage member to a hydraulic adjusting unit acting on the guide jaws.

It is thereby preferably provided that hydraulic medium is fed, via a flexible supply line routed to the carriage member, to the hydraulic feed provided in the carriage member, wherein the flexible supply line is capable of following the movements of the carriage member parallel to the workpiece spindle axis.

In particular, in this case, it is provided that the flexible supply line is routed from a side of the working area opposite an end face of the spindle drum to the carriage member.

It is particularly favourable if the respective workpiece guide bushing is adjustable by means of a control unit, in particular a medium control unit, in respect of a radial force acting on the material bar for the guidance thereof.

The medium can be, for example, air or a gas.

A preferred solution provides that the medium is a hydraulic medium, which enables an effect on the guide jaws which is realisable with a simple space-saving construction as well as being quick.

In the case of an acuation of the guide jaws with a medium, in particular a medium generating the radial force, an elastic element which acts upon the guide jaws in the direction away from the material bar in order to support a release of the guidance is suitably provided.

It is particularly favourable in the solution according to the invention if the workpiece guide bushings, in respect of their radial force with which they act on the material bar for the guidance thereof, are controllable in a process-dependent manner, so that the precision of the guidance of the material bar can be controlled in a process-dependent manner.

Furthermore, it is preferably provided that the workpiece guide bushings are fixable by controlling the radial force against a movement relative to the material bar in the direction parallel to the respective workpiece spindle axis.

Such a fixing of the workpiece guide bushings can be used particularly advantageously if a spindle drum indexing takes place for moving the workpiece spindles from one spindle station into the next and thereby the danger exists that the workpiece guide bushings move relative to the material bar in a direction parallel to the workpiece spindle axis.

A particularly advantageous solution provides that by means of the control unit, in particular the media control unit, the respective radial force is set to a releasing radial force level at which the material bar is freely movable, and in particular is rotatable, relative to the workpiece guide sleeve.

Alternatively or additionally, by means of the control unit, the respective radial force is set to a guiding radial force level at which the material bar is displaced relative to the workpiece guide bushing, and thus supported and guided on the guide bushing in a direction parallel to the respective workpiece spindle axis, although the guide sleeve is driven by the material bar due to the friction provided by the guiding radial force level.

Alternatively or additionally, it is further provided that by means of the control unit, the respective radial force is set to a clamping radial force level at which the material bar is firmly clamped in the guide sleeve and thus can neither be displaced parallel to the respective workpiece spindle axis nor rotated relative to the guide sleeve.

With regard to the possibility that the workpiece guide bushings can be displaced relative to the material bar when shifting the spindle drum, it has proved to be particularly advantageous if by means of a machine control system, a control of the workpiece guide bushings is provided, which on indexing the spindle drum, fixes the workpiece guide bushings relative to the material bar by increasing the radial force of the guide jaws against a movement in the direction parallel to the respective workpiece spindle axis and after ending of an indexing of the spindle drum, reduces the radial force far enough that for long turning, a displacement of the workpiece guide bushing relative to the material bar with simultaneous precise support and guidance thereof transversely to the workpiece spindle axis is possible.

Thus, the possibility exists of selecting the precision of the guidance of the material bar according to the machining and, secondly, when spindle indexing, of fixing the workpiece guide bushing relative to the material bar.

A particularly favourable solution provides that the machine control system changes the rotary speed of the respective workpiece spindle only in the presence of the clamping radial force level, so that it is thereby ensured that the guide sleeve also undergoes the change in the rotary speed of the workpiece spindle.

Furthermore, it is preferably provided that the machine control system leaves the rotary speed of the respective workpiece spindle unchanged in the presence of the guiding radial force level, so that a slight friction is sufficient to ensure the carrying along of the guide sleeve of the workpiece guide bushing at the respective rotary speed.

A further advantageous solution provides that, in the presence of the releasing radial force level, the machine control system operates the respective workpiece spindle at standstill with regard to its rotary motion, which means that at the releasing radial force level, the material bar does not rotate, but can be pushed through the static guide sleeve of the workpiece guide bushing.

Finally, it is suitably provided that, during the indexing of the spindle drum, the machine control system adapts the rotary speed of the workpiece spindle to the rotary speed required in the next spindle station, so that the time of the indexing of the spindle drum can be used to set the respective new rotary speed, wherein suitably during the indexing of the spindle drum, the clamping radial force level is applied and thus necessarily a carrying along of the guide sleeve takes place during the rotary speed change.

With regard to the machining of the material bars, no further details have so far been given.

Preferably, associated with each spindle station is at least one tool carrier, by means of which a tool held thereby is movable both in the X-direction transversely to the respective workpiece spindle axis and also in the Z-direction parallel to the respective workpiece spindle axis.

Preferably, the tool carriers are arranged to be static on the machine frame and associated with the respective spindle stations.

In particular, two tool carriers are associated with at least a part of the spindle stations in order to increase the number of tools available for machining in the respective spindle station.

Furthermore, so far it has not been considered in detail how the displacement of the workpiece guide bushing parallel to the workpiece spindle axis is to take place.

In principle, it is conceivable to associate a displacement drive with each workpiece guide bushing.

Such a displacement drive could be, for example, an electric displacement drive, for example, by means of an adjusting spindle or a toothed bar, or a pneumatic or a hydraulic displacement drive.

However, in order to configure the solution according to the invention particularly simple in constructional terms, it is preferably provided that the workpiece guide bushing is displaceable by means of the respective tool carrier of the, in particular, respective spindle station in the direction parallel to the workpiece spindle axis.

This means that no displacement drive associated specifically with the workpiece guide bushing is required, but rather the displacement of the workpiece guide bushing takes place by means of the at least one tool carrier operating in the respective spindle station.

In the case of a plurality of, for example two, tool carriers associated with a spindle station, it is preferably provided that one of the tool carriers is provided to displace the workpiece guide bushing in the direction of the workpiece spindle axis, whilst further, for example the other, tool carrier or carriers is or are controlled and moved by means of a machine control system provided for control of the tool carriers, following the tool carrier displacing the workpiece guide bushing, so that thereby, a collision of the tools during the machining of the material bar can simultaneously be prevented.

The displacement of the workpiece guide bushing by means of the tool carrier can be solved particularly easily if the tool carrier is provided with a first driver element for displacing the respective workpiece guide bushing.

The first driver element could thereby act directly on the workpiece guide bushing in order to displace it.

It has, however, proved to be advantageous if the workpiece guide bushing comprises a second driver element cooperating with the first driver element, so that by means of this cooperation of the driver elements, a displacement of the workpiece guide bushing can be realised.

However, in order to be able, during indexing of the spindle drum and thus also the moving of the workpiece guide bushing with the spindle drum, to release and to re-establish the coupling of the workpiece guide bushings to the statically arranged tool carrier, it is preferably provided that the driver elements are bringable, through movement of the tool carrier in the X-direction transversely to the workpiece spindle axis, into or out of operative connection.

This means, for example, that a movement of the tool carrier in the X-direction initiated, in particular, by a machine control system toward the workpiece spindle axis creates the operative connection between the driver elements and a movement of the tool carrier, initiated in particular by the machine control system, in the X-direction away from the workpiece spindle axis releases the operative connection of the driver elements.

In order to be able to displace the workpiece guide bushing in at least one spindle station easily and, in particular, independently of the tool carriers, it is preferably provided that a displacing device is associated with the one spindle station, with which displacing device the workpiece guide bushing situated therein is displaceable.

Thereby, the possibility exists of displacing the workpiece guide bushing into the desired position in this station without the movability of a tool carrier in the Z-direction having to be used for this.

It is particularly favourable if the displacing device comprises a displacing cylinder and a displacing arm and that the workpiece guide bushing is displaceable with the displacing arm.

Thereby, the displacing arm can act directly on the workpiece guide bushing at each suitable location.

It is particularly favourable if the displacing arm acts on a driver element provided on the workpiece guide bushing, for example, the aforementioned second driver element.

In principle, such a displacing device for displacing the workpiece guide bushing could be implemented in any provided position.

Particularly advantageously, the displacing device can be used if, with the displacing device, a displacement of the workpiece guide bushing away from the respective workpiece spindle head takes place.

In particular, this solution provides that with the displacing device, a displacement of the workpiece guide bushing takes place into the position maximally removed from the workpiece spindle head.

Such a displacement is advantageous, in particular, in the first spindle station in which a feeding of the material bar takes place, since in this station, simultaneously with the feeding of the material bar, the workpiece guide bushing is to be displaced into the position maximally removed from the workpiece spindle head, in which a machining of the material bar in the first spindle station begins.

Then, starting, in particular, from the first spindle station, for example, a displacement of the workpiece guide bushing by a tool carrier associated with the respective spindle station takes place.

Furthermore, the invention relates to a method for operating a multi-spindle lathe comprising a machine frame, a spindle drum mounted on the machine frame so as to be rotatable about a spindle drum axis, workpiece spindles each arranged in a spindle position on the spindle drum and each mounted to be rotatable relative to the spindle drum about a workpiece spindle axis, said workpiece spindles being positionable by rotating the spindle drum about the spindle drum axis, for machining workpieces arranged in said workpiece spindles, into different spindle stations which are arranged statically relative to the machine frame.

In a method of this type, it is provided according to the invention that associated with each workpiece spindle is a workpiece guide bushing which is displaced, during the machining of a material bar as the workpiece, in the direction of the workpiece spindle axis, that in each of the workpiece guide bushings, the material bar is guided coaxially with the workpiece spindle axis through a guide sleeve which can freely rotate relative to an external housing of the workpiece guide bushing.

It is thereby provided in a simple manner to carry out long turning according to the Offenbach system in a multi-spindle machine tool.

It is particularly favourable if the workpiece guide bushings act upon the material bar by means of the guide sleeve with a varying radial force.

For example, it is provided for this purpose that in the guide sleeve which is rotatable coaxially with the workpiece spindle axis, the material bar is guided through guide jaws that are placeable thereon.

It is thereby suitable for exerting the radial force if, in each workpiece guide bushing, the guide jaws can be displaced radially to a guidance axis of the guide sleeve.

The possibility therefore suitably exists that the workpiece guide bushings act by means of the guide jaws with the radial force on the material bar.

In order to generate the radial force, it is suitably provided that a medium is fed to each workpiece guide bushing for radially displacing the guide jaws.

An advantageous possibility provides that, by means of a control unit in the respective workpiece guide bushing, the radial force acting on the material bar for guidance thereof is adjusted, whereby the control unit is preferably a medium control unit with which a pressure of the medium is adjustable.

It is particularly favourable if in the workpiece guide bushings according to the invention, the radial force with which they act upon the material bar for guidance thereof is controlled in a process-dependent manner, so that during the machining process and between the machining processes, the radial force can be varied in each case and can be adapted according to the requirements of the machining process or the activities occurring between the machining processes.

Furthermore, it is preferably provided that the workpiece guide bushings can be fixed by controlling the radial force against a movement relative to the material bar in the direction parallel to the respective workpiece spindle axis.

A particularly advantageous solution provides that by means of the control unit, the respective radial force is set to a releasing radial force level at which the material bar is freely movable and, in particular, is freely rotatable relative to the guide sleeve.

Alternatively or additionally, a further solution provides that by means of the control unit, the respective radial force is set to a guiding radial force level at which the material bar can be displaced in a supported and guided manner relative to the workpiece guide bushing in a direction parallel to the respective workpiece spindle axis, although the guide sleeve is co-rotated by the material bar due to the friction provided by the guiding radial force level.

Alternatively or additionally, a further suitable solution provides that by means of the control unit, the respective radial force is set to a clamping radial force level at which the material bar can neither be displaced relative to the guide sleeve parallel to the respective workpiece spindle axis nor rotated relative to the workpiece guide sleeve.

In particular, in an advantageous solution, it is provided that by means of a machine control system, in particular during actuation of the control unit by the machine control system, an actuation of the workpiece guide bushings is provided, which on indexing the spindle drum, fixes the workpiece guide bushings relative to the material bar by increasing the radial force of the guide jaws against a movement in the direction parallel to the respective workpiece spindle axis and after the ending of the indexing of the spindle drum, reduces the radial force far enough that for long turning, a displacement of the workpiece guide bushing relative to the material bar with simultaneous precise support and guidance thereof transversely to the workpiece spindle axis is possible.

A particularly favourable implementation provides that the machine control system changes the rotary speed of the respective workpiece spindle only in the presence of the clamping radial force level, so that it is thereby ensured that the guide sleeve always also performs the change of the rotary speed of the workpiece spindle and so also rotates at the rotary speed of the material bar.

Alternatively or additionally, it is provided that the machine control system leaves the rotary speed of the respective workpiece spindle unchanged in the presence of the guiding radial force level.

A further suitable solution provides that the respective workpiece spindle is operated by the machine control system in the presence of the releasing radial force level at standstill with regard to its rotary motion.

A further favourable solution provides that during the indexing of the spindle drum, the machine control system adapts the rotary speed of the workpiece spindles to the rotary speed required in the next spindle station.

Alternatively or in addition to the aforementioned method features, the invention relates to a method for operating a multi-spindle lathe in which, according to the invention, associated with each workpiece spindle is a workpiece guide bushing for guidance of a material bar which is held in the workpiece spindle for long turning and is displaced relative to the respective workpiece spindle in a direction parallel to the workpiece spindle axis during long turning. An advantageous variant thereby provides that associated with each spindle station is at least one tool carrier, by means of which a tool held thereby is movable both in the X-direction transversely to the respective workpiece spindle axis and also in the Z-direction parallel to the respective workpiece spindle axis.

In particular, the possibility exists thereby that the workpiece guide bushing is displaced by the respective tool carrier in a direction parallel to the respective workpiece spindle axis in order so to position the workpiece guide bushing that only the machined sections of the material bar protrude beyond the workpiece guide bushing.

In particular, in the case of a plurality of tool carriers, it is provided that the workpiece guide bushing is displaced by one of the tool carriers, whilst at least one further tool carrier is moved by means of a machine control system following the one tool carrier, that is, follows its movements.

Thereby, in particular, the one tool carrier operates as closely as possible to the guide bushing and, by means of the at least one tool carrier, at a somewhat greater spacing from the guide bushing.

It is particularly favourable if the respective workpiece guide bushing is displaced by a first driver element arranged on the tool carrier. Furthermore, it is preferably provided in addition thereto that the workpiece guide bushing is moved by a second driver element cooperating with the driver element.

In order to be able to release and to re-establish the coupling between the tool carrier moving the workpiece guide bushing and the workpiece guide bushing, it is preferably provided that the respective driver element is brought, through a movement of the tool carrier in the X-direction transversely to the workpiece spindle axis, into or out of operative connection.

Further features and advantages of the invention are the subject matter of the following description and of the illustration in the drawings of some exemplary embodiments.

### BRIEF DESCRIPTION OF THE DRAWINGS

FIG. 1 shows a perspective view of a working area and of the units arranged in the working area of a first exemplary embodiment of a machine tool according to the invention;

FIG. 2 shows a central vertical section through a machine frame of the machine tool with the spindle drum in a sectional plane in which a spindle drum axis lies;

FIG. 3 shows a horizontal section through the machine frame of the machine tool according to the invention in a sectional plane in which the spindle drum axis lies;

FIG. 4 shows a perspective view similar to FIG. 1 without the workpiece guide bushings provided according to the invention, with a perspective view of the workpiece spindles of the spindle drum situated in individual spindle stations;

FIG. 5 shows a perspective view according to FIG. 4 with additionally shown workpiece guide bushings which are positioned on the working area side in front of the workpiece spindles of the spindle drum;

FIG. 6 shows a section along the line 6-6 in FIG. 5 without taking account of tools and tool carriers;

FIG. 7 shows a side view in the direction of the arrow B in FIG. 5, omitting the tool carriers;

FIG. 8 shows an enlarged section in a sectional plane extending through the spindle drum axis through a carrier unit carrying the workpiece guide bushings and a region of the spindle drum holding the carrier unit;

FIG. 9 shows a section in a sectional plane extending through the workpiece spindle axis and the spindle drum axis through a first exemplary embodiment of a workpiece guide bushing with a foot member carrying said workpiece guide bushing and with a part of the carrier unit accommodating the foot member;

FIG. 10 shows a section in a sectional plane extending through the spindle drum axis with a sectional representation of the carrier unit and a representation of a duct extending in continuation of the carrier unit through the working area;

FIG. 11 shows a plan view in the direction of the arrow C in FIG. 10;

FIG. 12 shows a plan view in the direction of the arrow A in FIG. 1 with tools mounted in the tool carriers;

FIG. 13 shows a side view of a workpiece guide bushing in relation to a tool carrier moving it in a direction parallel to the workpiece spindle axis and the carrier unit;

FIG. 14 shows a perspective view of an interaction of a first driver element arranged on a tool carrier with a second driver element arranged on the workpiece guide bushing;

FIG. 15 shows a perspective view of the tool carriers arranged in the working area of the first exemplary embodiment with the corresponding workpiece guide bushings;

FIG. 16 shows a section along the line 16-16 in FIG. 15;

FIG. 17 shows a perspective enlarged representation of a first spindle station of the multi-spindle machine tool according to the invention in which at the start of the machining, an insertion of a material bar into the respective workpiece spindle and pushing through of the material bar as far as into the workpiece guide bushing takes place;

FIG. 18 shows a schematically simplified representation of the pushing of the material bar through the workpiece guide bushing in the first spindle station;

FIG. 19 shows a schematic representation of the machining of the material bar taking place in the first spindle station after pushing of the material bar through the workpiece guide bushing over a machining length BL1;

FIG. 20 shows a schematic representation of the machining of the material bar in the second spindle station in the region of a machining length BL2;

FIG. 21 shows a representation of the machining of the material bar in a third spindle station over a machining length BL3;

FIG. 22 shows a schematic representation of a machining of the material bar in a fourth spindle station over a machining length BL4;

FIG. 23 shows a schematic representation of the machining of the material bar in a fifth spindle station over a machining length BL5;

FIG. 24 shows a schematic representation of a parting off of the machined part of the material bar in the sixth spindle station by means of a synchronous spindle;

FIG. 25 shows a reverse side machining of the portion of the material bar machined in the synchronous spindle;

FIG. 26 shows a schematic construction of a hydraulic control unit controlled by a machine control system;

FIG. 27 shows a flow scheme of the processes beginning in the first spindle station as far as the third spindle station with representation of the rotary speed of the workpiece spindles and the pressures for generating the respective radial force level; and

FIG. 28 shows a section in a sectional plane extending through the workpiece spindle axis and the spindle drum axis through a workpiece guide bushing according to a second exemplary embodiment of the machine tool according to the invention with a foot member carrying said workpiece guide bushing and with a part of the carrier unit accommodating the foot member.

### DETAILED DESCRIPTION OF THE INVENTION

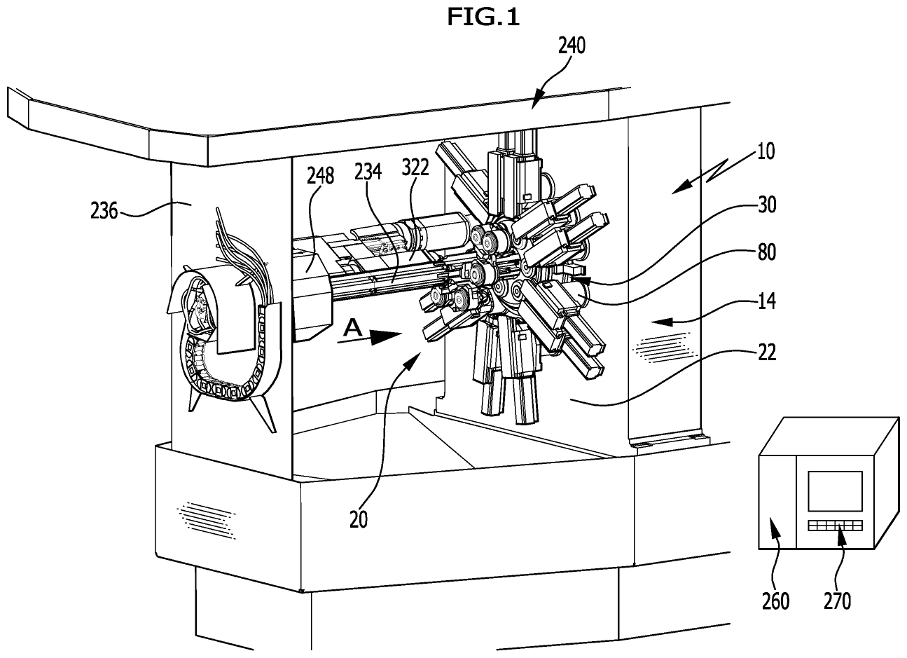

An exemplary embodiment shown in FIGS. 1 to 5 of a multi-spindle lathe according to the invention comprises a machine frame 10 which has a machine frame base 12 on which a spindle drum housing 14, comprising a front wall 16 and a rear wall 18 is arranged, wherein the spindle drum housing 14 has a front side 22 facing a working area 20 of the multi-spindle lathe and a rear side 24 facing away from the working area 20, wherein the front wall 16 and the rear wall 18 extend transversely to the machine frame base 12 and upwardly away therefrom, and wherein the spindle drum housing 14 sits with an underside 26 on the machine frame base 12.

Mounted in the spindle drum housing 14 is a spindle drum identified overall as 30, which is rotatable around a spindle drum axis 32 relative to the spindle drum housing 14.

Thereby, the mounting of the spindle drum 30 takes place via spindle drum bearings 34 and 36 arranged circumferentially to the spindle drum 30, on the front wall 16 and/or the rear wall 18, which mount the spindle drum 30 to be rotatable about the spindle drum axis 32, but non-diplaceably in the direction of the spindle drum axis 32.

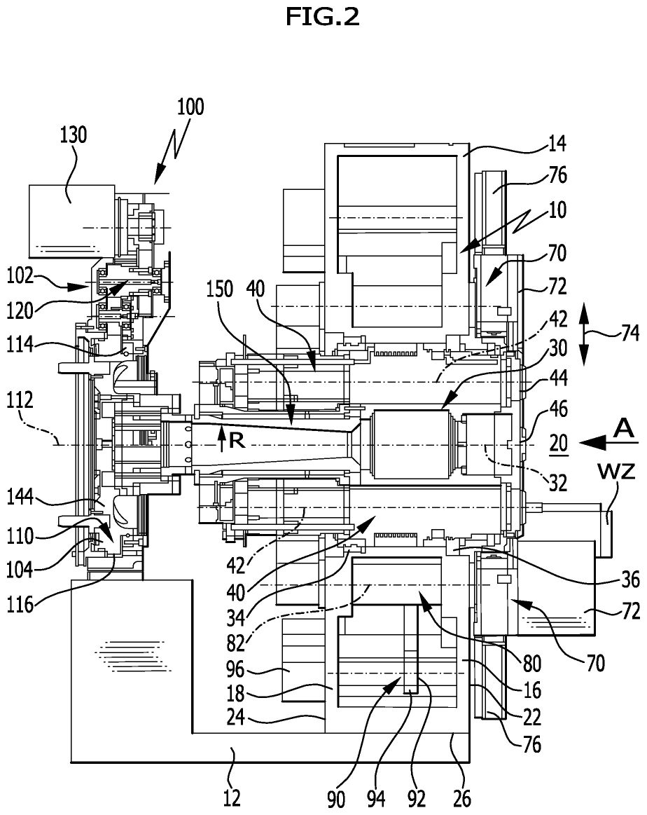

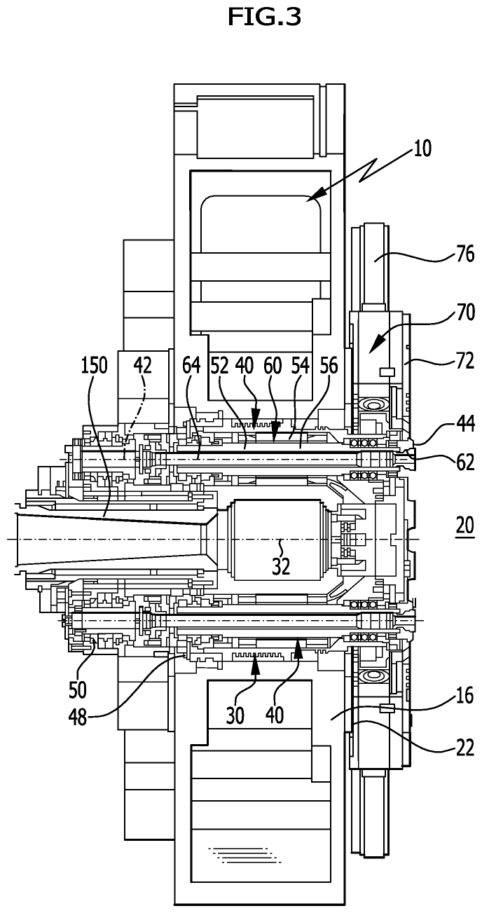

As shown in particular in FIGS. 2 and 3, there is a plurality of workpiece spindles 40 in the spindle drum 30, for example, six workpiece spindles 40 arranged around the spindle drum axis 32 preferably at equal angular spacings and at the same radial spacing, so that workpiece spindle axes 42 of the workpiece spindles 40 extending parallel to the spindle drum axis 32 have a constant radial spacing from the spindle drum axis 32 and a constant angular spacing from one another.

In particular, the workpiece spindles 40 are held in the spindle drum 30 non-displaceably in a direction parallel to their workpiece spindle axes 42.

As also shown in FIG. 3, each of the workpiece spindles 40 has a workpiece spindle head 44 which faces toward the working area 20 and lies in the region of a front side 46 of the spindle drum 30, and preferably protrudes therebeyond, whereby the front side 46 of the spindle drum 30 also faces toward the working area 20.

Starting from the workpiece spindle head 44, each of the workpiece spindles 40 extends in the direction of its workpiece spindle axis 42 through the spindle drum 30 as far as a clamping drive 50 arranged at a rear side 48 of the spindle drum 30.

Furthermore, each of the workpiece spindles 40 has a spindle tube 52 which is rotatably mounted in the spindle drum 30 and carries a rotor 54 of a spindle motor identified as a whole as 60, the stator 56 of which is arranged stationary in the spindle drum 30.

The spindle tube 52 thereby carries a clamping device 62 for a workpiece W in the region of the spindle head 44, said clamping device being actuatable by the clamping drive 50.

In addition, each of the workpiece spindles 40 and each clamping drive 50 associated with one of the workpiece spindles 40 has a central passage 64 through which a material bar WS forming workpieces can be pushed so that a material bar WS is insertable through the clamping drive 50 into the workpiece spindle 40 and is movable therethrough as far as the clamping element 62, so that the material bar WS ultimately protrudes, with a portion forming the workpiece, beyond the spindle head 44 and is fixable by means of the clamping element 62 for machining.

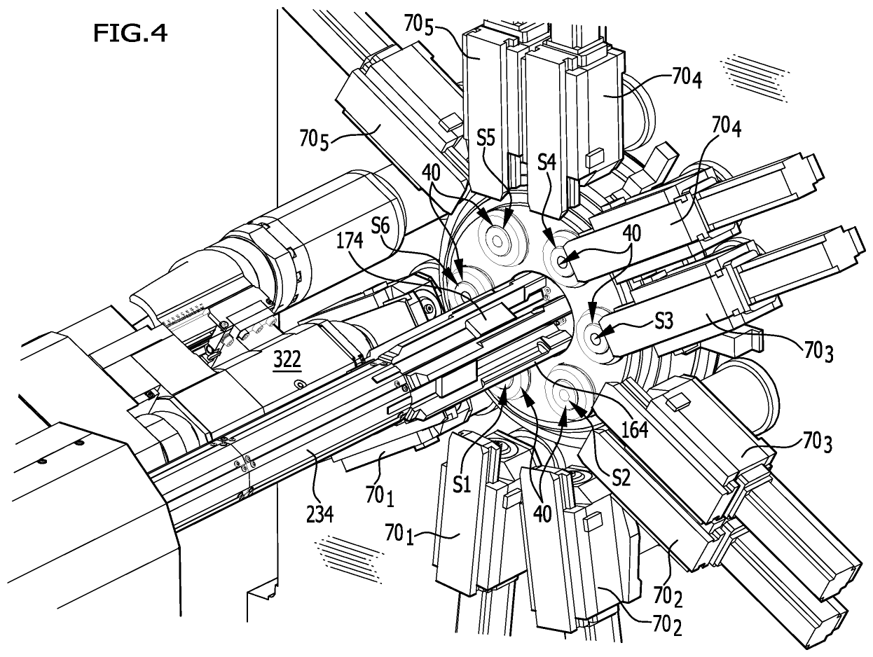

As shown in FIGS. 2 and 3, the spindle drum 30 is rotatable round the spindle drum axis 32 in the spindle drum housing 14, specifically so that the workpiece spindles 40 are situated in defined pre-determined spindle stations, for example, the spindle stations S1 to S6 (FIG. 4) and on further rotation of the spindle drum 30, are again situated in one of the spindle stations S1 to S6, whereby however, the respective workpiece spindle 40 is not situated in the same spindle station S1 to S6, but in another of the spindle stations S1 to S6, for example, in the next successive spindle station. For example, an indexing of the spindle drum 30 takes place such that each of the workpiece spindles 40 successively passes through all the spindle stations S1 to S6.

For machining the material bars WS received in the workpiece spindles 40 in the spindle stations S1 to S6, at least one tool carrier 70 is associated with each of the spindle stations S1 to S6, said tool carrier carrying the tools required for the turning machining of the workpiece W (FIGS. 2 and 4).

In the exemplary embodiment shown (FIG. 4) of the multi-spindle lathe according to the invention, according to FIG. 4, associated with each of the spindle stations S1 to S5 are two such tool carriers 70, each of which is arranged in front of a front side 22 of the spindle drum housing 14.

Each of the tool carriers 70 (FIG. 2) has, for example, an X-carriage 72 which is movable linearly in a displacement direction 74 which extends radially to the workpiece spindle axis 42 of the workpiece spindle 40 situated in the respective spindle station S1 to S6 and thus corresponds in each of the spindle stations S1 to S6 to the respective X-axis.

For this purpose, an X-displacement drive 76 is provided on the tool carrier 70 (FIG. 2).

Furthermore, as shown, for example, in FIG. 2, each of these tool carriers 70 is arranged on a sleeve 80 which penetrates the spindle drum housing 14 with a sleeve axis 82 extending parallel to the spindle drum axis 32, wherein the sleeve 80 is mounted, for example, in the spindle drum housing 14, for example, in the front wall 16 and the rear wall 18 of the spindle drum housing 14, displaceable in the direction of the sleeve axis 82, so that the entire tool carrier 70 is movable in a Z-direction through movement along the sleeve axis 82 relative to the workpiece spindle 40 situated in the respective spindle station S1 to S6, so that overall a tool WZ situated on the X-carriage 72 is movable relative to the material bar WS to be machined in the respective workpiece spindle 40 of the corresponding spindle station S1 to S6 at least in an X-direction by means of the X-carriage 72 as well as in a Z-direction by displacement of the entire tool carrier 70 with the sleeve 80 along the sleeve axis 82.

For the displacement of the sleeve 80 along the sleeve axis 82, a Z-displacement drive identified overall as 90 is provided, which has, penetrating the spindle drum housing 14, a displacing spindle 92, the spindle nut 94 of which is coupled to the sleeve 80 and is situated between the front wall 16 and the rear wall 18 of the spindle drum housing 14. The displacing spindle 92 is furthermore drivable by means of a Z-drive motor 96 which is arranged on the rear side 24 of the spindle drum housing 14.

In order to be able to utilise the space available in the spindle drum housing 14 for the arrangement of sleeves 80 and Z-displacement drives 90 for an optimum number or a maximum number of tool carriers 70, a spindle drum drive identified as a whole as 100 is arranged at a spacing from the rear side 24 of the spindle drum housing 14 and also at a spacing from the rear side 48 of the spindle drum 30, said spindle drum drive having a drive housing 102 which is arranged on the machine frame base 12.

Arranged in a central recess 104 in the drive housing 102 is a driver gear wheel 110 which is rotatable about a gear wheel axis 112 which is arranged coaxially with the spindle drum axis 32.

The driver gear wheel 110 is therein mounted on the peripheral side in a driver gear wheel bearing 114 of the drive housing 102 and has a peripheral toothing 116 for the drive thereof also arranged in the central recess 104.

Furthermore, in the drive housing 102, a gearing unit 120 is provided which drives the driver gear wheel 110, firstly, via the peripheral toothing 116 and, secondly, is drivable by means of a drum drive motor 130.

For the rotary drive of the spindle drum 30 by the driver gear wheel 110, the driver gear wheel 110 is coupled to a drive connecting element identified as a whole as 150, which extends from the driver gear wheel 110 to the spindle drum 30 and is connected to the spindle drum 30 (FIGS. 2 and 3) for conjoint rotation.

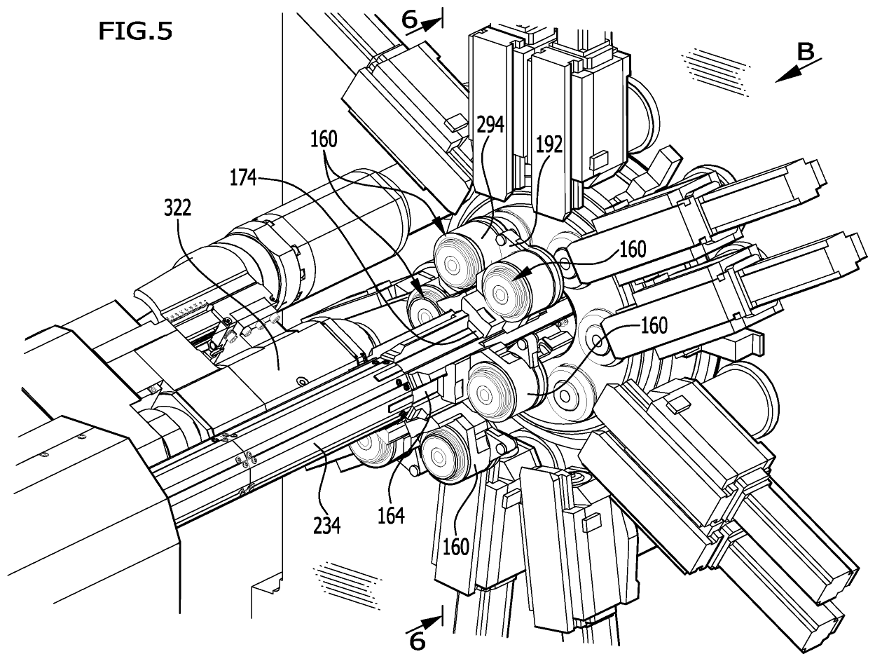

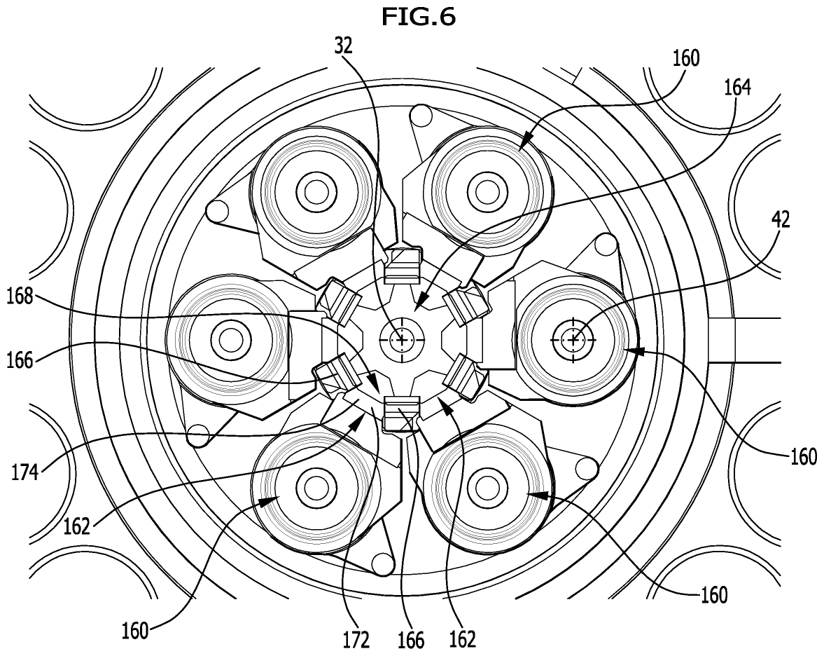

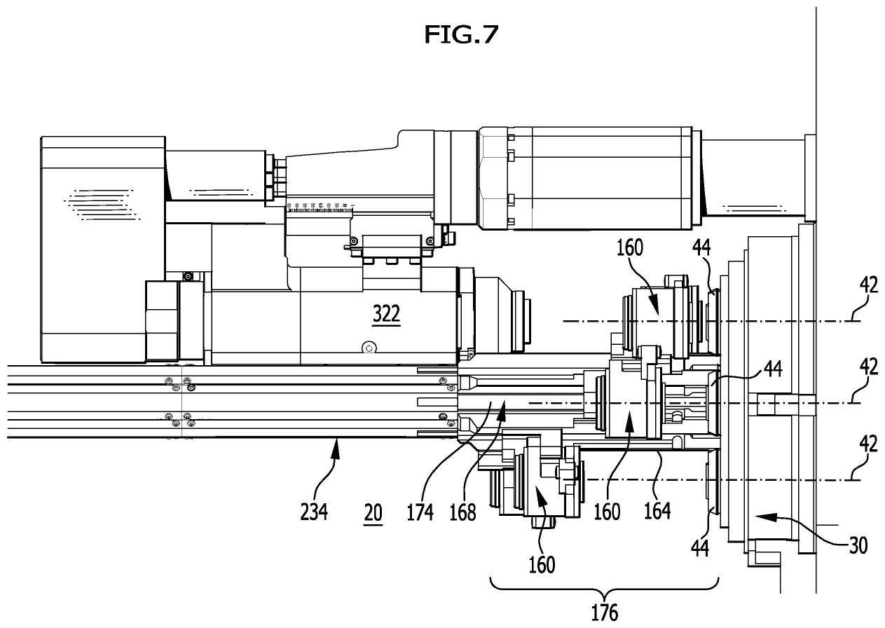

In the multi-spindle lathe according to the invention, as shown in FIGS. 1 and 5 to 8, provided in the working area 20 and in front of the respective workpiece spindle head 44 is a respective workpiece guide bushing 160 which is arranged coaxially with the respective workpiece spindle axis 42, said workpiece guide bushing being arranged with a foot member 162 on a carrier unit 164 and guided in the direction parallel to the respective workpiece spindle axis 42 (FIGS. 5, 6).

For this purpose, the carrier unit identified overall as 164, itself being coaxial with the spindle drum axis 32 has, for each of the foot members 162, a guide duct 172 delimited in each case on both sides by longitudinal guides 166, in which guide duct the respective foot member 162 is guided by means of a carriage member 174 slidingly guided on the longitudinal guides 166, wherein the respective carriage member 174 is movable parallel to the respective workpiece spindle axis 42 along the longitudinal guides 166 (FIG. 6).

Thereby, the longitudinal guides 166 each form, with the guide duct 172 and the carriage member 174, a linear guide 168 for the respective workpiece guide bushing 160.

The respective workpiece guide bushing 160 is displaceable therewith relative to the respective workpiece spindle head 44 over a defined displacement range 176 relative to the respective workpiece spindle head 44.

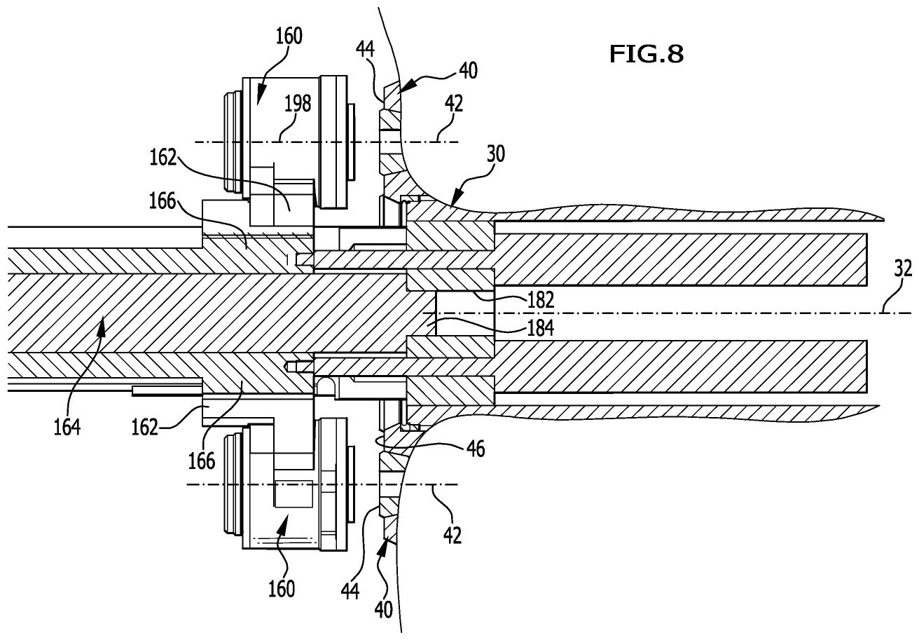

As shown in FIG. 8, for this purpose, the carrier unit 164 is mounted on the front side 46 of the spindle drum 30, preferably by means of a carrier receptacle 182 arranged coaxially with the spindle drum axis 32, said carrier receptacle extending, starting from the front side 46 into the spindle drum and in which carrier receptacle the carrier unit 164 engages by means of a fixing member 184.

Thereby, the carrier unit 164 is held on the spindle drum 30 fixed, firstly, in a direction parallel to the spindle drum axis 32 and, secondly, in relation to a rotary movement relative to the spindle drum axis 32 and is thus rotatable together with the spindle drum 30 about the spindle drum axis 32, so that thereby, the workpiece guide bushings 160 also always remain oriented in their coaxial alignment with the workpiece spindle axis 42 of the respective workpiece spindle 40 and are displaceable only in the direction of the respective workpiece spindle axis 42 relative to the corresponding workpiece spindle head 44.

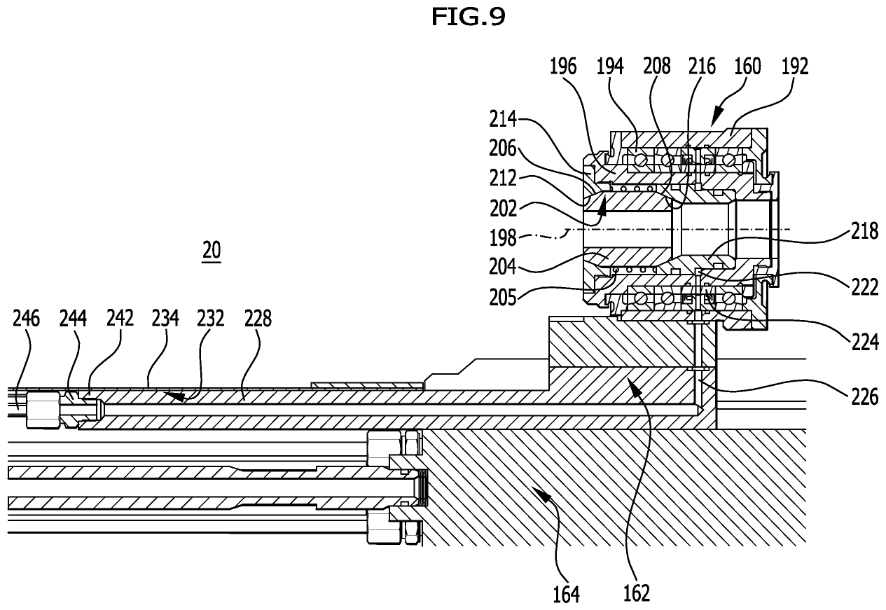

As shown in FIG. 9, each of the workpiece guide bushings 160 comprises an external housing 192 firmly connected to the foot member 162, in which external housing a guide sleeve 196 is mounted rotatable by means of a rotary bearing set 194 about a guide sleeve axis 198, wherein the guide sleeve axis 198 is arranged coaxially with the respective workpiece spindle axis 42.

Arranged in the respective guide sleeve 196 is a guide jaw set 202 which comprises guide jaws 204 which are movable radially to the guide sleeve axis 198, said guide jaws being provided radially externally on their end regions arranged at a spacing from one another in the direction of the guide sleeve axis 198 with pressure surfaces 206, 208 extending conically to the guide sleeve axis 198 and each declining toward the end of the guide jaws 204.

The pressure surfaces 206 thereby abut a complimentary conically formed support surface 212 of a support ring 214 firmly inserted into the guide sleeve 196, whereas the opposite pressure surfaces 208 abut a complementary conically shaped support surface 216 of an annular adjusting piston 218 which is displaceable parallel to the guide sleeve axis 198 and lies within said guide sleeve axis.

The adjusting piston 218 is thereby displaceable parallel to the guide sleeve axis 198 relative to the guide sleeve 196 in the direction of the support ring 214 or away from the support ring 214, in order, on a displacement in the direction of the support ring 214, to move the guide jaws 204 radially in the direction toward the guide sleeve axis 198 or, on a displacement away from the support ring 214, to permit a movement in the radial direction toward the guide sleeve axis 198 away therefrom, which is also assisted, in particular, by a spring 205 which acts upon the adjusting piston 218 in order to bias it in the direction away from the support ring 214.

For this purpose, formed between the adjusting piston 218 and the guide sleeve 196 is a cylinder chamber 222 which is connected via a pressure-tight hydraulic rotary feed 224 to a hydraulic duct 226 which extends through the external housing 192 and the foot member 162 and continues into a feed rail 228 formed on the foot member 162 and movable therewith, which extends from the foot member 162 in the direction away from the spindle drum 30 into the working area 20.

To the extent that the feed rail 228 protrudes in the respective position of the workpiece guide bushing 160 beyond the carrier unit 164, it extends into a duct 232 enclosed by a duct covering 234 which, as FIG. 1 shows, extends, starting from the carrier unit 164 through the entire working area 20 to a housing wall 236 of a machine housing 240 of the multi-spindle lathe positioned opposite the front side 22 of the spindle drum housing 14.

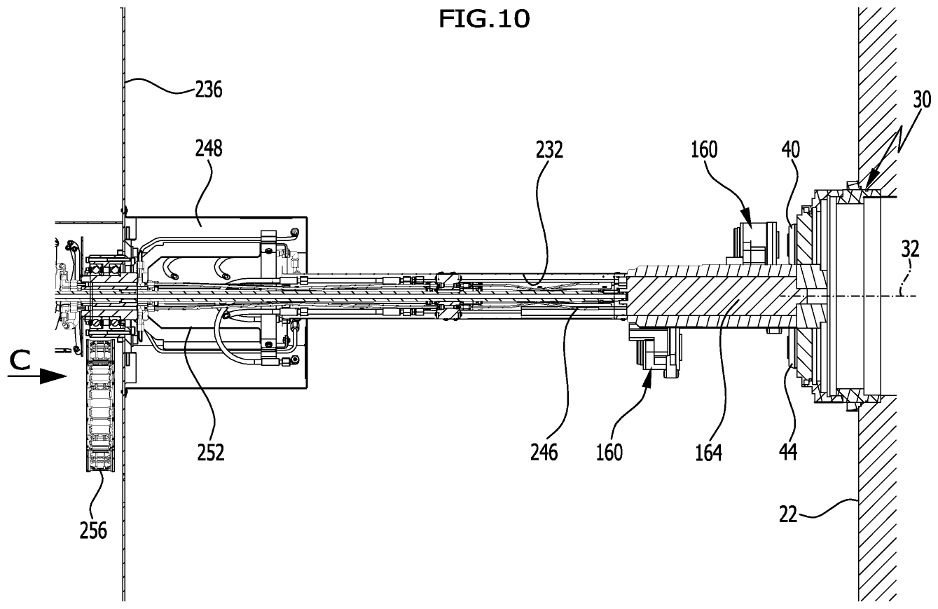

At an end 242 of the feed rail 228 facing away from the foot member 162 and facing toward the housing wall 236, a hydraulic connection 244 is provided which, as shown in FIGS. 9 and 10, creates a connection to the hydraulic line 246 which is fed through the duct 232 to a connection box 248 held on the housing wall 236 for the individual hydraulic lines 246 extending to the respective workpiece guide bushings 160, which are connected in the connection box 248 to a hydraulic unit 252.

Both the hydraulic unit 252 and also the duct covering 234 enclosing the duct 232 co-rotate during a rotation of the spindle drum 30 about the spindle drum axis 32, so that the hydraulic lines 246 extending from the feed rails 228 to the hydraulic unit 252 undergo no torsion, but are only displaced in the direction parallel to the spindle drum axis 32 and possibly transversely thereto in the duct 232, specifically depending upon the position of the workpiece guide bushing 160 with the foot member 162 relative to the respective workpiece spindle head 44.

The hydraulic unit 252 is therein connected to hydraulic lines 254 which are guided via a carrying chain 256 (FIGS. 10 and 11), which is windable in a plane extending perpendicularly to the spindle drum axis 32 and coinciding in FIG. 11 with the drawing plane, on a rotation of the spindle drum 30 about the spindle drum axis 32, specifically so that a rotation of the spindle drum 30 about the spindle drum axis 32 is possible to the extent that the workpiece spindle 40 situated in the spindle station S1 reaches the spindle station S6 and then again a rotation of the spindle drum takes place in the reverse rotation direction, as described with regard to the guidance of a supply strand from the machine control system to the individual spindle drums in this context in European patent application 0 755 316 A.

The hydraulic lines 254 are themselves connected to a hydraulic control unit 260 (FIG. 1) which is controllable by a machine control system 270 which controls all the functions of the multi-spindle lathe.

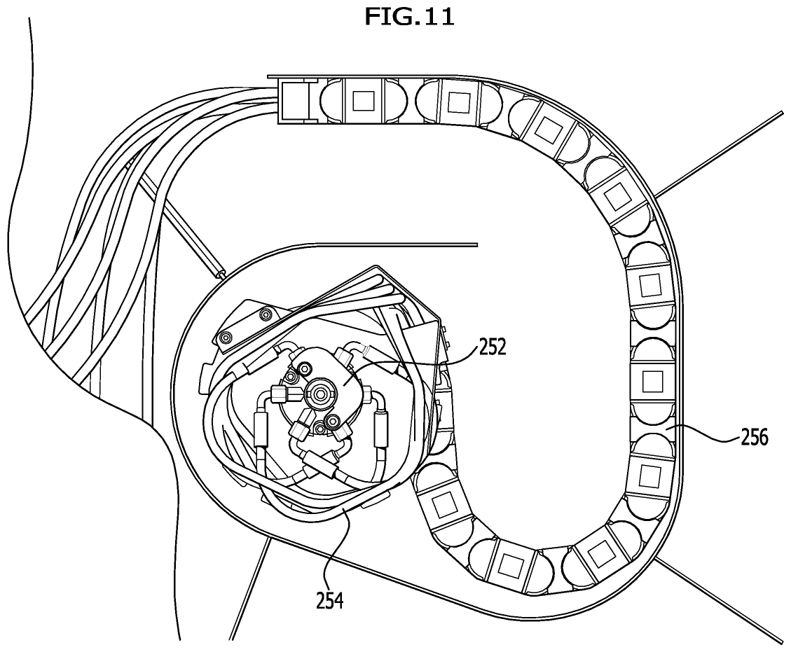

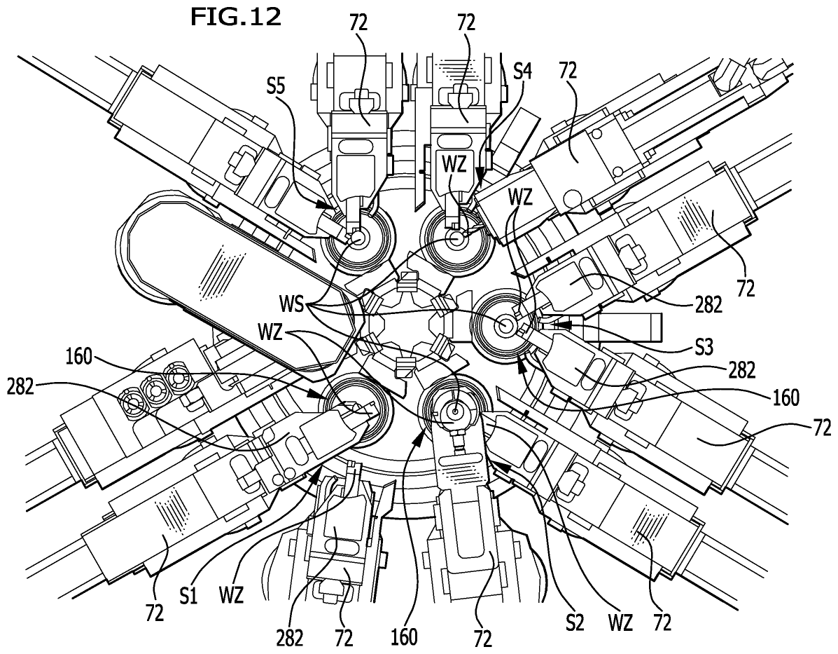

In the multi-spindle lathe according to the invention, as shown in FIG. 12, the respective X-carriages 72 of the tool carrier 70 are provided with tool holders 282 which position the respective tools WZ so that they can machine a workpiece on a side of the respective workpiece guide bushing 160 facing away from the workpiece spindle head 44, so that the workpiece in the form of a material bar WS extends through the workpiece spindle 40 and the clamping element 62 of the respective workpiece spindle 40 is clamped, but extends beyond the respective workpiece spindle head 44 through the workpiece guide bushing 160 and is guided in the workpiece guide bushing 160 by the guide jaws 204, the radial advance of which in the direction toward the guide sleeve axis 198 which is coaxial with the workpiece spindle axis 42 is controllable by the hydraulic control unit 260 and thus also by the machine control system 270, so that the precision of the guidance of the material bar can be adapted to the respective machining.

In order now to be able to carry out a long turning according to the Offenbach system with such a workpiece guide bushing 160, as already described in detail, the workpiece guide bushing 160 is displaceable in the direction of the respective workpiece spindle axis 42 relative to the material bar firmly clamped with the clamping element 62 in the workpiece spindle 40 according to the machining progress during long turning.

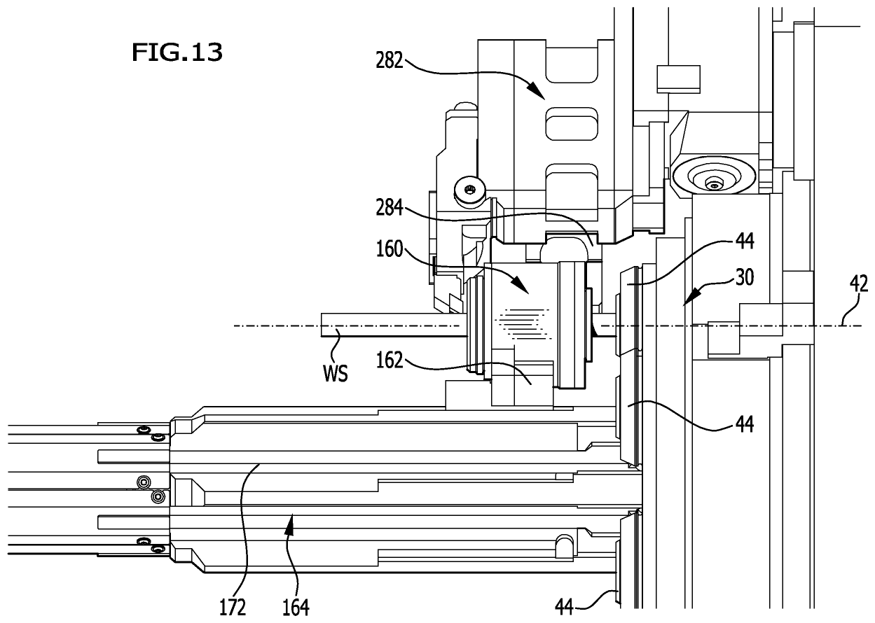

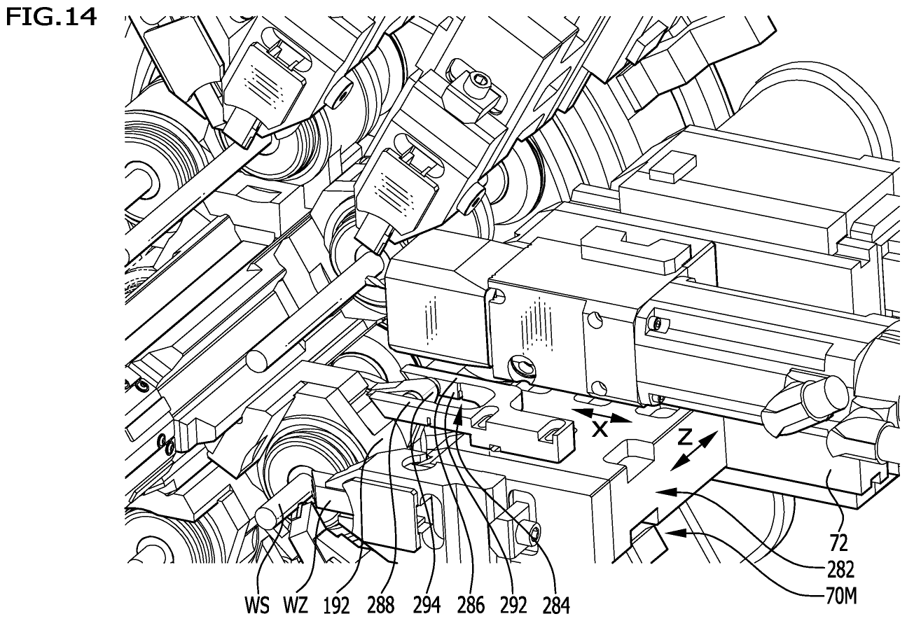

The displacement of the respective workpiece guide bushing 160 takes place, as shown in FIGS. 13 and 14, by means of a tool carrier 70 associated with the respective spindle station S1 to S6, the tool holder 282 of which is provided with a driver fork 284 which has two fingers 286 and 288, so that in an intermediate space 292 between these two fingers 286, 288, a driver arm 294 which is arranged, for example, on the external housing 192 of the respective workpiece guide bushing 160 can be accommodated.

Thereby, the fingers 286 and 288 of the driver fork 284 extend, for example, parallel to the X-direction along which the respective tool holder 282 is movable by means of the respective tool carrier 70, wherein the driver fork 284 is dimensioned such that, on a movement of the tool holder 282 away from the material bar WS, the driver fork comes out of engagement with the driver arm 294, so that a decoupling takes place between the tool holder 282 and the workpiece guide bushing 160, whilst on a movement of the tool holder 282 in the direction of the material bar WS, the driver arm can be accommodated in the intermediate space 292 between the fingers 286 and 288 of the driver fork.

In this position in which the driver arm 294 lies between the fingers 286 and 288 of the driver fork 284, by means of a movement of the tool carrier 70 in the Z-direction, the workpiece guide bushing 160 can also be moved parallel to the Z-direction and thus also coaxially with the workpiece spindle axis 42 relative to the material bar WS fixed in the workpiece spindle 40, together with the tool holder 282.

In the case of the spindle stations S1 to S5 in each of which two tool carriers 70 are arranged, in each case, one of the tool carriers 70 is provided with the driver fork 284 and is thus regarded by the machine control system 270 for the machining of the material bar WS as the definitive tool carrier 70 or the master tool carrier 70M, whereas the other tool carrier 70 is moved with regard to its positioning relative to the definitive tool carrier 70 and thus functions as a slave tool carrier 70S.

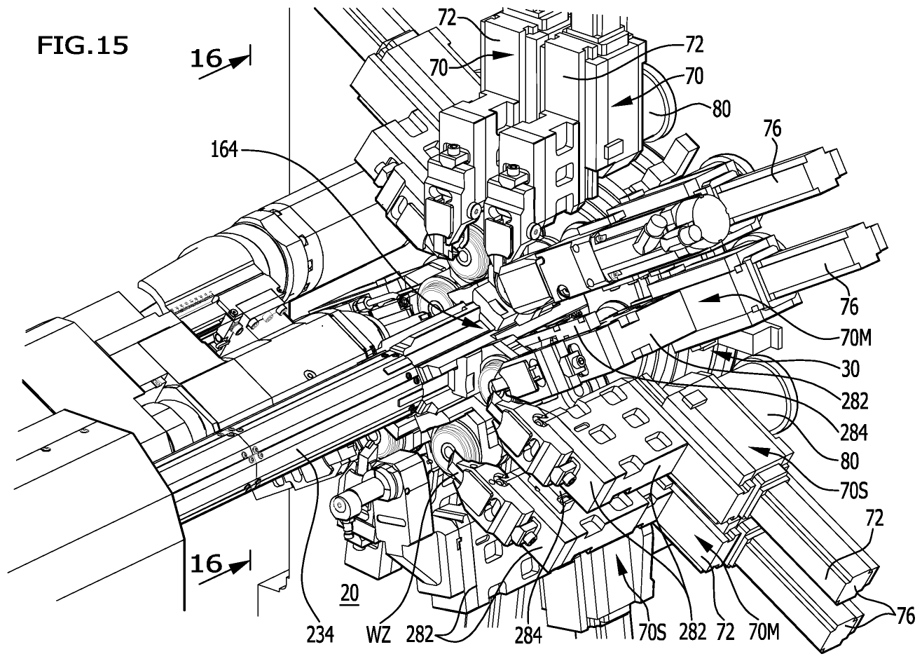

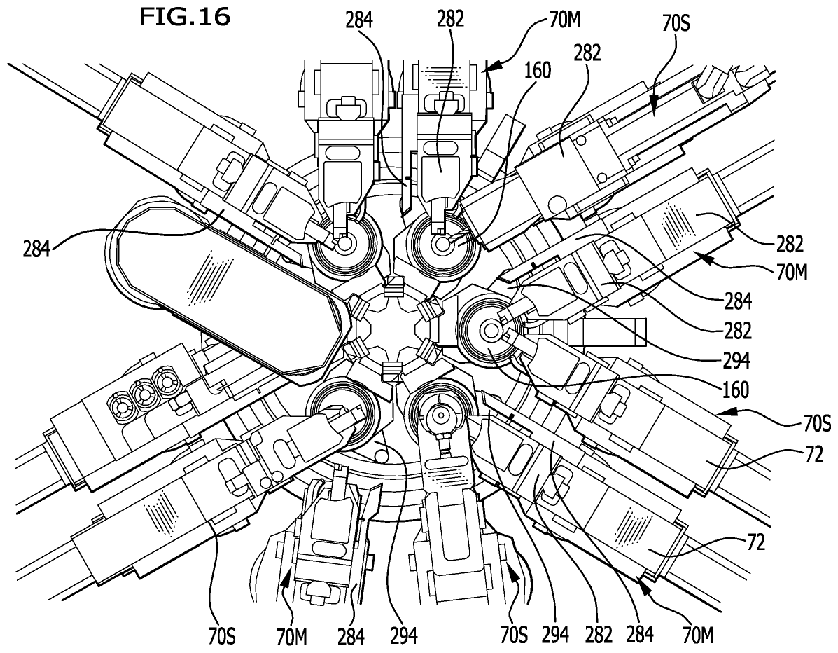

It is thereby prevented that the tools WZ of the two tool carriers 70 that are associated with one of the spindle stations S collide with one another and also that a collision with the respective workpiece guide bushing 160 takes place, since said bushing is always positioned, by reason of the driver fork 284, so that it is arranged in a collision-free manner relative to the tool WZ of the respective master tool carrier 70M (FIG. 15).

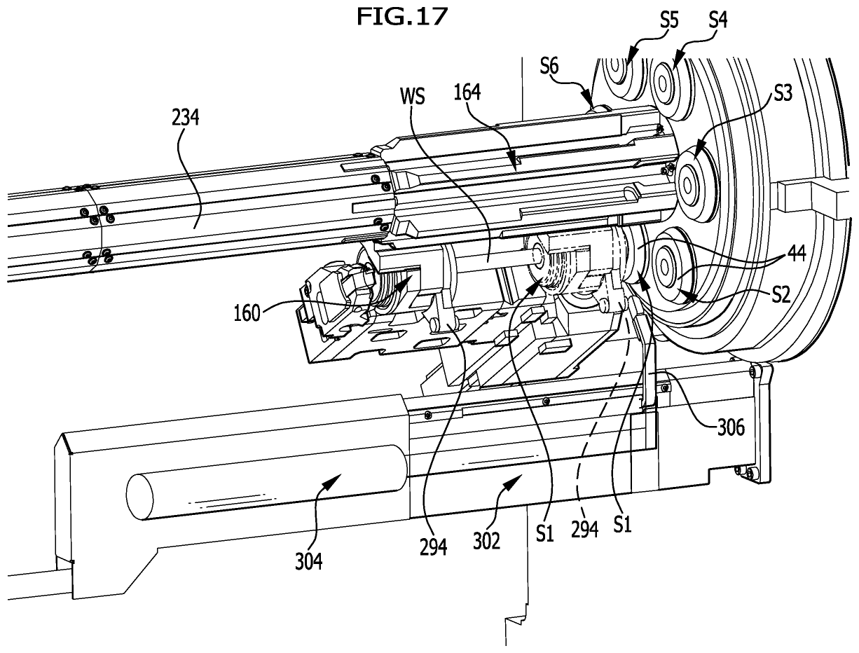

In order to be able to displace the workpiece guide bushing 160 in the spindle station S1 from a position situated near the workpiece spindle head 44 into a position at a maximum distance from the workpiece spindle head 44 in which an insertion of the material bar WS takes place, a displacing device identified overall as 302 is associated with the spindle station S1 (FIG. 17), which displacing device comprises, for example, a displacing cylinder 304 which is oriented parallel to the respective workpiece spindle axis 42 in the spindle station S1 and at one end carries a displacing arm 306 which is able to cooperate with the driver arm 294 of the workpiece guide bushing 160 situated in this spindle station S1 in order to be able to bring the workpiece guide bushing 160 into a position maximally spaced from the workpiece spindle head 44.

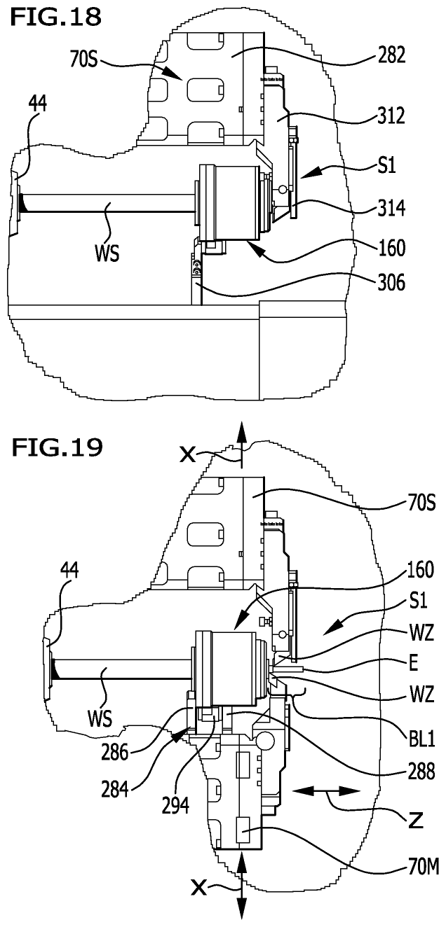

This position can be individually specified, for example, by means of a tool shaft 312 of the tool carrier 70M associated with the spindle station S1, wherein the tool shaft 312 also carries an end stop 314 for the material bar WS which, with the clamping element 62 released, is pushed through the workpiece spindle 40 situated in this spindle station S1 and into the workpiece guide bushing 160 until the material bar WS protrudes beyond the workpiece guide bushing 160 on a side facing away from the spindle head 44 for machining (FIG. 18) and abuts the end stop 314.

The material bar WS is thereby guided through the workpiece guide bushing 160 at a spacing from the spindle head 44, whilst the tools WZ of the tool carriers 70M and 70S enter into engagement through movement thereof in the X-direction and, if appropriate, in the Z-direction on the end portion of the material bar protruding beyond the workpiece guide bushing 160 during the subsequent machining, as shown in FIG. 19.

At the same time, by means of the bringing into engagement of the tool WZ of the tool carrier 70M, its driver fork 284 is moved in the direction of the driver arm 294 far enough that the driver arm 294 lies between the fingers 286 and 288 and, by means of the movement of the tool carrier 70M is jointly moved in the Z-direction, wherein during long turning, in each case, a machining of the material bar starting from its end E takes place in the direction of the spindle head 44 (FIG. 19).

The machining of the material bar starting from its end E takes place, for example, in the first spindle station S1 over a machining length BL1 by means of the tools WZ of the two tool carriers 70M and 70S (FIG. 19).

After machining of the machining length BL1, a movement of the tools WZ of the tool carriers 70M and 70S takes place in the X-direction away from the material bar WS so that subsequently an indexing of the spindle drum 30 can take place in which both the workpiece spindle 40 and also the associated workpiece guide bushing 160 are moved together from the spindle station S1 into the spindle station S2.

The tool carriers 70M and 70S associated with the spindle station S2 are moved, for example, during the indexing of the spindle 40 in the Z-direction into a starting position in which at least the tool carrier 70M of the spindle station S2 is able to embrace the driver arm 294 with its driver fork 284.

On reaching the spindle station S2, the tools WZ of the tool carriers 70M and 70S each provided in this spindle station S2 are again moved in the X-direction toward the material bar in order to machine it and simultaneously again to embrace the driver arm 294 with the driver fork 284 associated with the tool carrier 70M, in order to displace the workpiece guide bushing 160 according to the movements of the tool carrier 70M in the Z-direction in the direction of the spindle head 44.

Furthermore, the tool carriers 70M and 70S are again moved in the spindle station S1, for example, during the indexing of the spindle drum 40, into the position shown in FIG. 18 in which the end stop 314 delimits the advancing of the material bar WS, so that subsequently a new material bar WS can again be advanced in the spindle station S1.

In order to prevent unwanted displacement of the workpiece guide bushings 160 relative to the material bar WS during indexing of the spindle drum 30 and thus on movement of the workpiece guide bushing 160 from the spindle station S1 into the spindle station S2, by means of the machine control system 270 which controls the indexing of the spindle drum 30, the hydraulic control unit 260 is also controlled, specifically such that in all the workpiece guide bushings 160, it increases the hydraulic pressure and thus the radial force in the direction of the material bar WS during the indexing from one spindle station S into another spindle station S, in order by means of the existing guide jaw set 202, to fix the workpiece guide bushing 160 relative to the material bar WS in force-locking manner against movement parallel to the workpiece spindle axis 42.

As soon as the next spindle station, for example, the spindle station S2 is reached, this increased radial force of the guide jaw set 202 in the direction of the material bar WS is released again, so that the usual guidance of the material bar WS for long turning can be carried out with a radial force in the workpiece guide bushing 160 provided for the precision of the machining during the machining in this spindle station, for example, the spindle station S2.

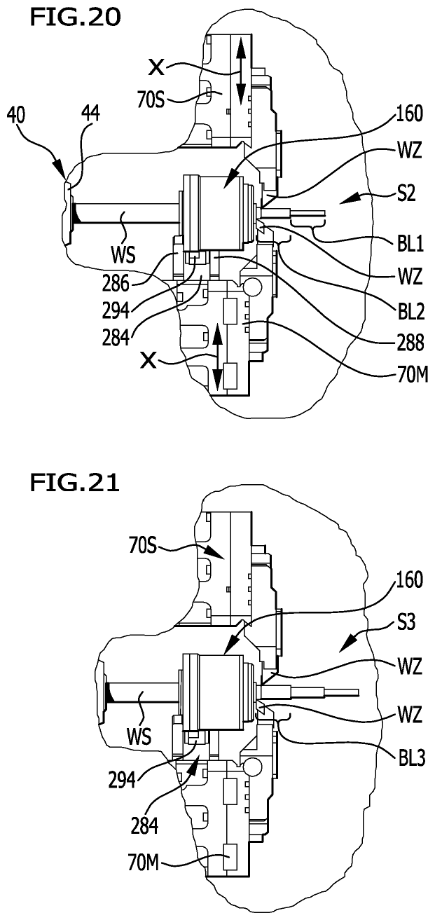

In the spindle station S2, for example, a machining of the material bar WS over the machining length BL2 which adjoins the machining length BL1 thus takes place (FIG. 20).

The indexing into the spindle station S3 takes place in the same way as the indexing from the spindle station S1 into the spindle station S2, wherein in the next spindle station S3, the tool carrier 70M associated therewith also again embraces the driver arm 294 with the driver fork 284 and is therefore in the position, also during the machining in the third spindle station S3, to displace the workpiece guide bushing 160 parallel to the workpiece spindle axis 42, for example, over the machining length BL3 over which a machining of the material bar WS takes place in the third spindle station (FIG. 21).

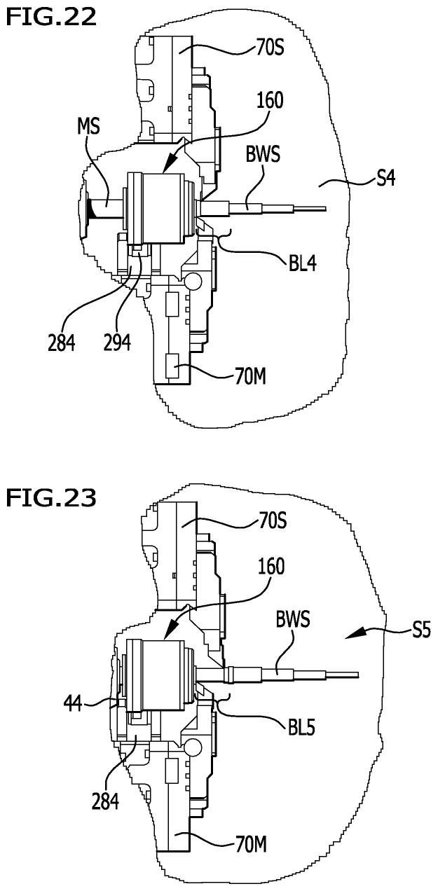

In the same way, an indexing from the third spindle station into the fourth spindle station S4 takes place, as shown in FIG. 22, wherein a machining of the material bar WS takes place over the machining length BL4 and also a driving of the workpiece guide bushing 164 by means of the driver fork 284 engaging with the driver arm 294 of the workpiece guide bushing 160.

In the fifth spindle station S5, a machining of the material bar WS over the machining length BL5 also takes place with the material bar supported by the workpiece guide bushing 160 which protrudes, at the end of the machining, beyond the machining length BL5 close to the workpiece spindle head 44, wherein a displacement of the workpiece guide bushing 160 over the machining length BL5 also takes place by means of the driver fork 284 arranged on the tool carrier 70M (FIG. 23).

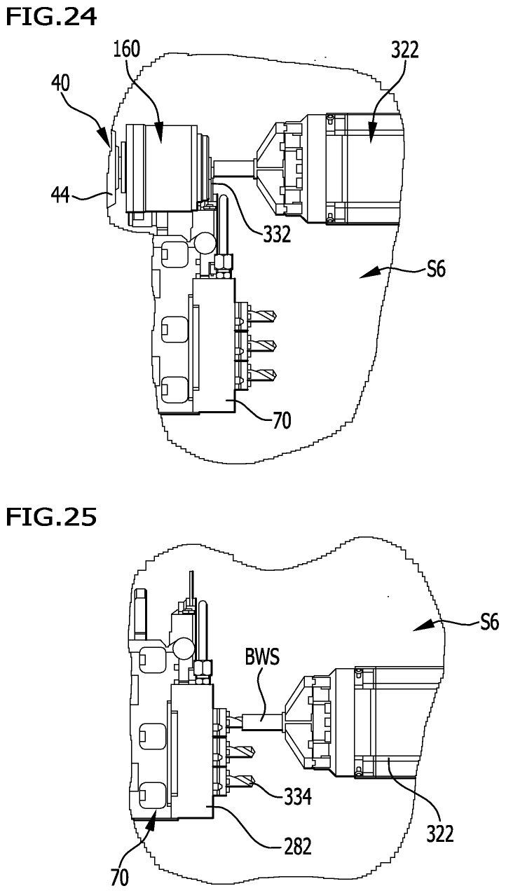

In the last spindle station S6 as shown, for example, in FIG. 24, a synchronous spindle 322 is provided which is pivotable in and is alignable coaxially with the workpiece spindle 40, so that with this synchronous spindle 322, a gripping of the machined side BWS of the material bar WS can take place and, by means of a parting-off tool 332, the parting of the machined part of the material bar WS therefrom takes place near to the workpiece guide bushing 160.

In addition, as shown in FIG. 25, rear machining of the machined portion of the material bar WS is possible in the spindle station S6 with tools 334 which are arranged on the tool holder 282, whereby these tools 334 extend, for example, away from the tool holder 282 of the tool carrier 70.

It is possible even during the rear machining, as shown in FIG. 25, to rotate the spindle drum 30 back contrary to the previous rotation direction, so that the workpiece spindle 40 is again situated in the spindle station S1 in which initially a displacement of the workpiece guide bushing 160 into the position maximally spaced from the workpiece spindle head 44, as shown in FIG. 18, and then an insertion of the material bar WS and a pushing thereof through the workpiece guide bushing 160 takes place, so that the machining of a new material bar WS begins (FIG. 19).

In relation to the exemplary embodiment described above, it was not considered how the radial force is generated and controlled.

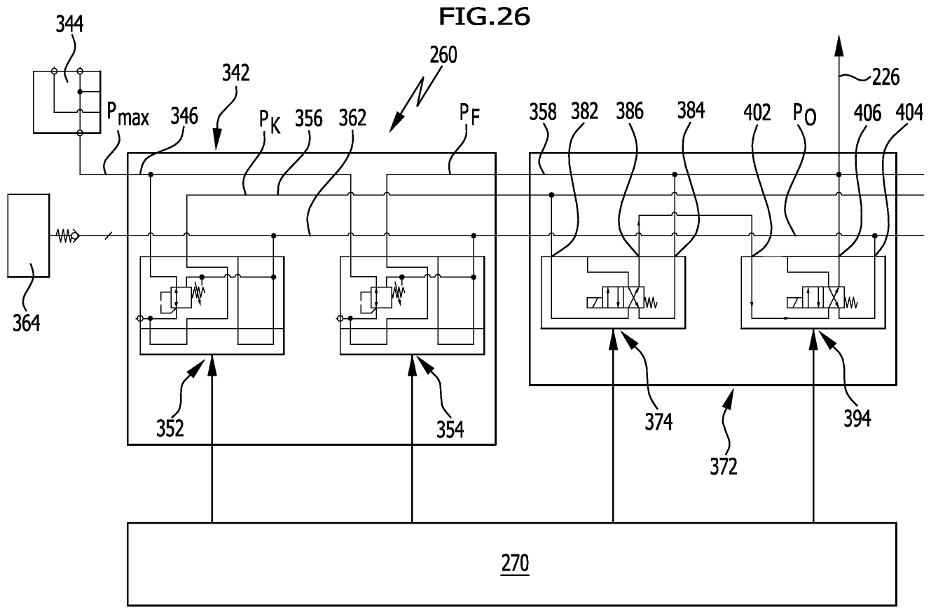

An exemplary embodiment of a hydraulic control unit 260 according to the invention, shown in FIG. 26 and also shown together with the machine control system 270 in FIG. 1, comprises a central pressure supply identified overall as 342 which is connected to a pressure generating unit 344 which makes hydraulic medium available with a maximum pressure Pₘₐₓ which is fed via a pressure line 346 to the central pressure supply 342.

In the central pressure supply 342, for example, two pressure reducers 352 and 354 are arranged which further reduce the pressure Pₘₐₓ available via the pressure line 346.

For example, the pressure reducer 352 reduces the pressure Pₘₐₓ to a clamping pressure P_{κ} and is connected to a clamping pressure line 356, via which the clamping pressure P_{κ} is passed on, as described in detail below.

The clamping pressure P_{κ} is selected so that on application of the clamping pressure P_{κ} in the cylinder chamber 222 of the guide bushing 160 and thus on application of this clamping pressure P_{κ} to the adjusting piston 218, the adjusting piston 218 acts on the guide jaw set 202 such that it peripherally clamps the material bar WS fed through the guide jaw set 202 and thus fixes the material bar WS relative to the guide sleeve 196, so that overall, relative to the guide sleeve 196, the material bar WS is neither rotatable nor displaceable in the direction of the respective workpiece spindle axis 42.

The pressure reducer 354 reduces the pressure Pₘₐₓ to a value P_{F} and is connected to a clamping pressure line 358, via which the guidance pressure P_{F} is made available, as described in detail below.

The guidance pressure P_{F} is thereby selected such that on application of this guidance pressure P_{F} in the cylinder chamber 22 and the action of this guidance pressure P_{F} on the adjusting piston 218, the guide jaw set 202 acts peripherally on the respective material bar WS with a radial force that is only so large that the guide sleeve 196 together with the guide jaw set 202 is still displaceable in the direction parallel to the respective workpiece spindle axis 42, but the material bar WS is precisely guided radially to the guide sleeve axis 198 and thus also radially to the respective workpiece spindle axis 42.

However, the guidance pressure P_{F} is large enough so that the guide jaw set 202 abuts the material bar WS peripherally with a radial force strong enough that due to the friction between the material bar WS and the guide jaw set 202, a rotary driving of the guide sleeve 196 takes place and thus the guide sleeve 196 co-rotates with the material bar WS in the workpiece guide bushing 160.

For the function of the pressure reducers 352 and 354, these are also connected to the return line 362 for the hydraulic medium, which leads to a hydraulic reservoir 364 and is kept substantially pressure free at the pressure P₀.

Proceeding from this hydraulic reservoir 364, by means of the pressure generating unit 344, the hydraulic medium is then converted to the maximum pressure Pₘₐₓ.

The clamping pressure line 356, the guidance pressure line 358 and the return line 362 are now fed to a series of pressure switch units 372, wherein such a pressure switch unit 372 is fixedly associated with each workpiece guide bushing 160 and switches the pressure in the hydraulic duct 226 feeding to the respective guide bushing 160 in order to set the pressure application to the adjusting piston 218.

Each of the pressure switch units 372 comprises a first switch valve 374 which is connected at a first input 382 to the clamping pressure line 356 and at a second input 384 to the guidance pressure line 358 and is thus able to place an output 386 thereof either at clamping pressure P_{κ} or at guidance pressure P_{F}.

A second switch valve 394 of the respective pressure switch unit 372 has a first input 402 which is connected to the output 386 of the switch valve 374, and a second input 404 which is connected to the return line 362, and an output 406, which is connected to the hydraulic duct 226.

The second switch valve 394 is thus able to place at its output 406 either the pressure applied to its input 402, which corresponds, depending upon the position of the switch valve 374 to the clamping pressure P_{κ} or the guidance pressure P_{F}, or to place at its output 406 the pressure P₀ present in the return line 362, which corresponds to a substantially pressure-free state.

Thus, by means of the respective pressure switch unit 372, when applying the clamping pressure P_{κ}, the guidance pressure P_{F} or the pressure P₀ to the cylinder chamber 222 and the adjusting piston 218, a respectively different radial force level is achieved with the guide jaw set 202, which force level leads however through the specific selection of the clamping pressure P_{κ}, the guidance pressure P_{F} or the pressure P₀ to three different defined radial force levels which permit an optimum processing during long turning.

For control of the hydraulic control unit 260, there occurs by means of the machine control system 270, at least one actuation of the switch valves 374 and 394 for switching on the clamping pressure P_{κ} or the guidance pressure P_{F} or the pressure P₀ corresponding to a pressure-free state in order to pre-determine the clamping radial force level, the guiding radial force level or the releasing radial force level of the guide jaw set 202.

However, the possibility also exists on the part of the machine control system 270 to actuate the pressure reducers 352 and 354 in order, for example, when changing the material bar WS, by changing the clamping pressure P_{κ} and/or the guidance pressure P_{F}, to adapt the clamping radial force level and the guiding radial force level to the new material bar WS.

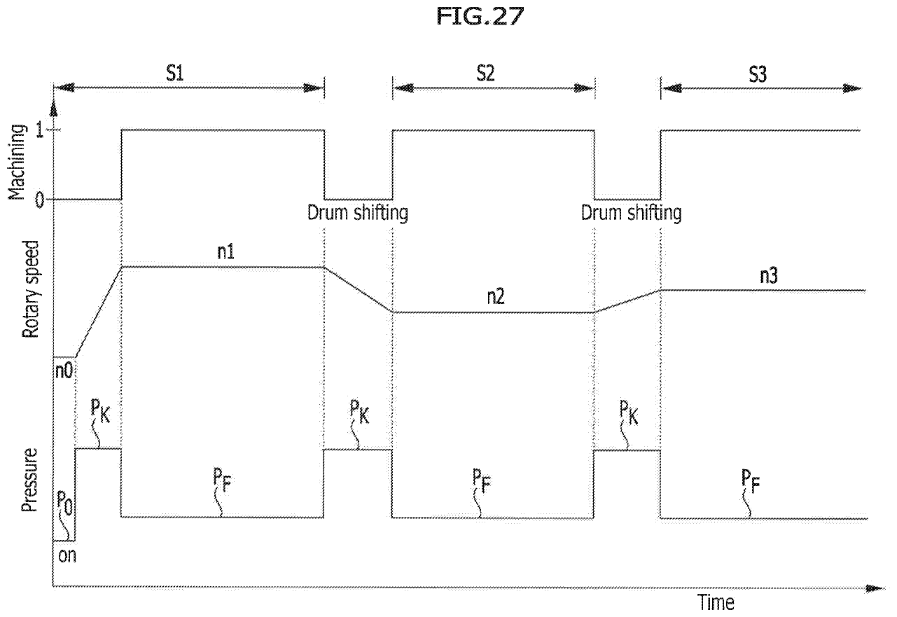

The machining of a material bar WS with a multi-spindle lathe controlled by such a hydraulic control system 260 is shown schematically, by way of example, in FIG. 27.

As previously described, the feeding of the material bar WS takes place in the spindle station 1 with an initially non-rotating workpiece spindle 40 and the introduction of the material bar WS into the workpiece guide bushing 160 as far as the end stop 314.

For this purpose, by means of the hydraulic control unit 260, in particular by means of the pressure switch unit 372 associated with the workpiece guide bushing 160 in the spindle station S1, the pressure in the hydraulic duct 226 is switched to the pressure P₀, so that the guide jaw set 202 generates no radial force at all and the guide jaws 204 are positioned at a sufficiently large spacing from the guide sleeve axis 198 that allows a pushing through of the material bar WS.

In order now to bring the material bar WS in the spindle station S1 to a machining speed and simultaneously to achieve that the guide sleeve 196 is also at the same rotary speed as the material bar WS, by means of the pressure switch unit 372, a switching on of the clamping pressure P_{κ} to the hydraulic duct 226 takes place by means of the pressure switch unit 372, so that the guide jaw set 202 fixes the guide sleeve 196 clampingly on the material bar WS.

In this state, the workpiece spindle 40 situated in the spindle station S1 can be accelerated from the static state (FIG. 27), expressed by the rotary speed n0, to the rotary speed n1 and it is ensured that the guide sleeve 196 is also accelerated with the material bar WS in the same way and thus also reaches the rotary speed n1 which is provided for machining the material bar WS in the spindle station S1 by means of the tools WZ.

In order now during the machining of the material bar WS by means of the tools WZ, to be able to displace the workpiece guide bushing 160 in the direction parallel to the respective workpiece spindle axis 42, after the workpiece spindle 40 reaches the rotary speed n1, the pressure switch unit 372 switches the guidance pressure P_{F} to the hydraulic duct 226 which is selected so that, firstly, a precise guidance of the material bar WS in the guide jaw set 202 takes place radially to the workpiece spindle axis 42 and radially to the guide sleeve axis 198, however the guide jaw set 202 is displaceable in the direction parallel to the workpiece spindle axis 42 situated in the spindle station S1, however at the same time, the radial force with which the clamping jaw set 202 acts peripherally on the material bar WS is so great that due to the friction, a co-rotation of the guide jaw set 202 and thus of the guide sleeve 196 takes place and thus the guide sleeve 196 co-rotates during the machining of the material bar WS at the rotary speed n1 of the workpiece spindle 40, also at the rotary speed n1.

On an indexing of the spindle drum 30, in order to move the workpiece spindle 40 with the guide sleeve 160 from the spindle station S1 into the spindle station S2, a fixing of the workpiece guide bushing 160 takes place, as stated above, in particular a fastening of the guide sleeve 196 by means of the guide jaw set 202 on the material bar WS for preventing a relative movement in the direction parallel to the workpiece spindle axis 42 and simultaneously a rotation-free fixing of the guide sleeve 196 by the clamping jaw set 202 on the material bar by switching on the clamping pressure P_{κ} to the hydraulic duct 226 by means of the pressure switch unit 372.

If now, during the drum indexing, the rotary speed of the workpiece spindle 40 is changed, for example, from the rotary speed n1 to the rotary speed n2, this necessarily has the consequence that the guide sleeve 196 with the guide jaw set 202 also undergoes this rotary speed change due to the clamping radial force level.

After reaching the spindle station S2, the pressure switch unit 372 again switches the guidance pressure P_{F} to the hydraulic duct 226 and thus the guide jaw set 202 acts with the guiding radial force level on the material bar WS so that, firstly, a displacement of the workpiece guide bushing 160 and thus of the guide sleeve 196 with the clamping jaw set 202 in the direction parallel to the workpiece spindle axis 42 is possible, but simultaneously, as before, a co-rotation of the guide sleeve 196 at the rotary speed n2 takes place.

The next indexing of the spindle drum 30 to move the workpiece spindle 40 from the spindle station S2 into the spindle station S3 also takes place by switching on the clamping pressure P_{κ} to the hydraulic duct 226 again and thus the creation of the clamping radial force level between the clamping jaw set 202 and the material bar WS, so that a rotary speed change in the workpiece spindle 40, for example, from the rotary speed n2 to the rotary speed n3 also brings about a corresponding rotary speed change of the guide sleeve 196 and of the clamping jaw set 202, so that after reaching the spindle station S3, a switching on of the guidance pressure P_{F} to the hydraulic duct 226 by the pressure switch unit 372 takes place again and, due to the guiding radial force level, the guide sleeve 196 is co-rotated with the clamping jaw set 202, including at the rotary speed n3, although a displacement of the workpiece guide bushing 160 with the guide sleeve 196 and the clamping jaw set 203 in the direction parallel to the workpiece spindle axis 42 can also take place.

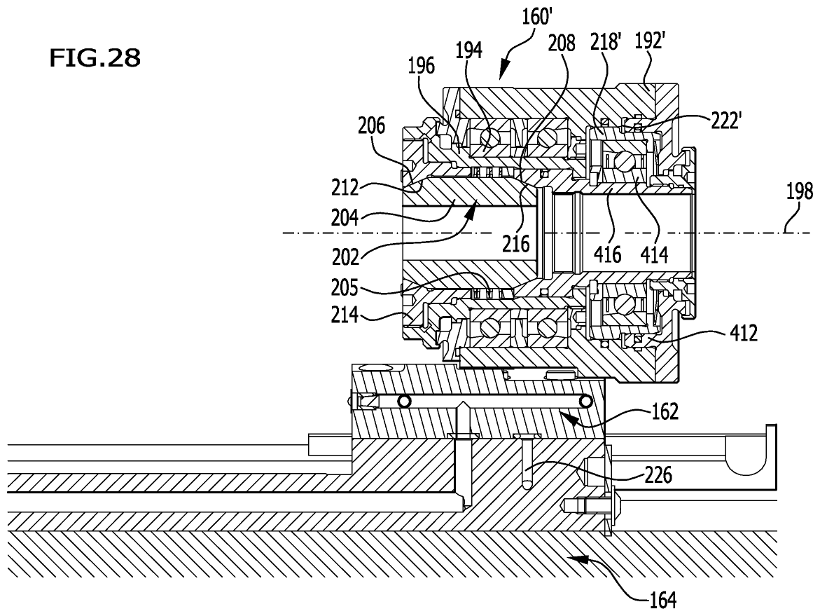

In a second exemplary embodiment of a workpiece guide bushing 160′ according to the invention, shown in FIG. 28, the guide sleeve 196, the protection ring 214, the guide jaws 202 with the guide jaws 204 are configured in the same way as in the first exemplary embodiment and are also rotatably mounted in the external housing 192 by means of the rotary bearing set 194.

In contrast to the first exemplary embodiment, in the second exemplary embodiment, the adjusting piston 218′ is not arranged co-rotatingly with the guide sleeve 196, but is arranged non-rotatably fixed in the external housing 192, so that the cylinder chamber 222′ is also arranged non-rotatably fixed and is delimited by the adjusting piston 218′, the external housing 192′ and a cover 412 of the external housing.

In this case, the adjusting piston 218′ is however displaceable in the same manner as in the first exemplary embodiment parallel to the guide sleeve axis 198.

The adjusting piston 218′ thereby acts on a rotary bearing 414, by means of which a support ring 416 which is rotatable with the guide sleeve 196 and is displaceable parallel to the guide sleeve axis 198 is coupled, said support ring having the conically shaped support surface 216 with which the displaceable support ring 416 acts upon the guide jaw set 202, in particular, upon the pressure surfaces 208 of the guide jaws 204, in order to move them in the radial direction relative to the guide sleeve axis 198, specifically in the same manner as described in relation to the first exemplary embodiment of the workpiece guide bushing 160.

The second exemplary embodiment has the advantage that by means of the non-rotatably arranged adjusting piston 218′, the hydraulic rotary feeds 224 configured to be pressure-tight can be omitted and thus, by means of the stationary arrangement of the cylinder chambers 222, a simple stationary connection to the hydraulic duct 226 is realisable.

Thus, in place of the hydraulic rotary feed 224 configured to be pressure-tight, in the second exemplary embodiment, the rotary bearing 414 is provided which transmits the movements of the adjusting piston 218′ to the displaceable support ring 416.

1. Multi-spindle lathe comprising
a machine frame,
a spindle drum mounted on the machine frame so as to be rotatable about a spindle drum axis,
workpiece spindles each arranged in a spindle position on the spindle drum and each mounted to be rotatable relative to the spindle drum about a workpiece spindle axis, said workpiece spindles being positionable by rotating the spindle drum about the spindle drum axis into different spindle stations which are arranged statically relative to the machine frame, for machining workpieces arranged in said workpiece spindles,
associated with each workpiece spindle is a workpiece guide bushing for guidance of a material bar held in the workpiece spindle for long turning, said material bar being arranged movably relative to the respective workpiece spindle in a direction parallel to the workpiece spindle axis.

2. Multi-spindle lathe according to claim 1, wherein each workpiece guide bushing is guided by means of a foot member on a carrier unit.

3. Multi-spindle lathe according to claim 1, wherein for each workpiece guide bushing, a linear guide is provided which movably guides the workpiece guide bushing in a direction parallel to the workpiece spindle axis.

4. Multi-spindle lathe according to claim 3, wherein the linear guide is arranged on a side of the respective workpiece guide bushing facing toward the spindle drum axis.

5. Multi-spindle lathe according to claim 4, wherein each linear guide comprises at least one longitudinal guide and a carriage member which is displaceably guided on the at least one longitudinal guide and carries the workpiece guide bushing.

6. Multi-spindle lathe according to claim 5, wherein the carriage member is part of the foot member.

7. Multi-spindle lathe according to claim 3, wherein the linear guides of all the workpiece guide bushings are arranged on a common carrier unit.

8. Multi-spindle lathe according to claim 2, wherein the carrier unit is arranged in a working area extending from a front side of the spindle drum.

9. Multi-spindle lathe according to claim 8, wherein the carrier unit extends in the direction parallel to the spindle drum axis.

10. Multi-spindle lathe according to claim 1, wherein the carrier unit is rotatable about the spindle drum axis and synchronously with the spindle drum.

11. Multi-spindle lathe according to claim 10, wherein the carrier unit is coupled to the spindle drum in a rotationally fixed manner.

12. Multi-spindle lathe according to claim 1, wherein the carrier unit is mounted on an end face of the spindle drum.

13. Multi-spindle lathe according to claim 12, wherein the carrier unit encroaches in the working area proceeding from the end face of the spindle drum.

14. Multi-spindle lathe according to claim 2, wherein proceeding from, and in extension of, the carrier unit, a duct extends further through the working area and emerges from the working area on a side opposite the end face of the spindle drum.

15. Multi-spindle lathe according to claim 1, wherein each of the workpiece guide bushings comprises a guide sleeve guiding the material bar coaxially with the workpiece spindle axis, said guide sleeve being freely rotatable relative to an external housing of the respective workpiece guide bushing.

16. Multi-spindle lathe according to claim 15, wherein the workpiece guide bushing acts by means of the guide sleeve with a radial force on the material bar.

17. Multi-spindle lathe according to claim 15, wherein guide jaws of the workpiece guide bushing which are placeable on the material bar are arranged in the guide sleeve which is rotatable coaxially with the workpiece spindle axis.

18. Multi-spindle lathe according to claim 15, wherein each workpiece guide bushing comprises guide jaws that are movable radially relative to a guidance axis of the guide sleeve.

19. Multi-spindle lathe according to claim 18, wherein each workpiece guide bushing acts by means of the guide jaws with the radial force on the material bar.

20. Multi-spindle lathe according to claim 18, wherein the guide jaws are radially displaceable by means of a medium.

21. Multi-spindle lathe according to claim 1, wherein a medium feed to each workpiece guide bushing takes place via the foot member of the respective workpiece guide bushing.

22. Multi-spindle lathe according to claim 1, wherein a duct for control is routed via the respective foot member to the respective workpiece guide bushing.

23. Multi-spindle lathe according to claim 22, wherein a hydraulic feed takes place via the carriage member to a hydraulic adjusting unit acting, for example, on the guide jaws.

24. Multi-spindle lathe according to claim 23, wherein hydraulic medium is fed, via a flexible supply line routed to the carriage member, to the hydraulic feed provided in the carriage member.

25. Multi-spindle lathe according to claim 24, wherein the flexible supply line is routed from a side of the working area opposite an end face of the spindle drum to the carriage member.

26. Multi-spindle lathe according to claim 1, wherein the respective workpiece guide bushing is adjustable by means of a control unit in respect of a radial force acting on the material bar for the guidance thereof.

27. Multi-spindle lathe according to claim 1, wherein the workpiece guide bushings in respect of their radial force with which they act on the material bar for the guidance thereof, are controllable in a process-dependent manner.

28. Multi-spindle lathe according to claim 1, wherein the workpiece guide bushings are fixable by controlling the radial force against a movement relative to the material bar in the direction parallel to the respective workpiece spindle axis.

29. Multi-spindle lathe according to claim 26, wherein by means of the control unit, the respective radial force is set to a releasing radial force level at which the material bar is freely movable relative to the guide sleeve and, in particular, is rotatable.

30. Multi-spindle lathe according to claim 26, wherein by means of the control unit, the respective radial force is set to a guiding radial force level at which the material bar is displaced relative to the workpiece guide bushing in a direction parallel to the respective workpiece spindle axis, although the guide sleeve is driven by the material bar due to the friction provided by the guiding radial force level.

31. Multi-spindle lathe according to claim 26, wherein by means of the control unit, the respective radial force is set to a clamping radial force level at which the material bar is firmly clamped in the guide sleeve and thus can neither be displaced relative to the guide sleeve parallel to the respective workpiece spindle axis nor rotated relative to the guide sleeve.

32. Multi-spindle lathe according to claim 1, wherein by means of a machine control system, a control of the workpiece guide bushings is provided, which on indexing the spindle drum, fixes the workpiece guide bushings relative to the material bar by increasing the radial force of the guide jaws against a movement in the direction parallel to the respective workpiece spindle axis and after ending of an indexing of the spindle drum, reduces the radial force far enough that for long turning there is possible a displacement of the workpiece guide bushing relative to the material bar with simultaneous precise support and guidance thereof transversely to the workpiece spindle axis.

33. Multi-spindle lathe according to claim 29, wherein the machine control system changes the rotary speed of the respective workpiece spindle only in the presence of the clamping radial force level.

34. Multi-spindle lathe according to claim 29, wherein, in the presence of the guiding radial force level, the machine control system leaves the rotary speed of the respective workpiece spindle unchanged.

35. Multi-spindle lathe according to claim 29, wherein, in the presence of the releasing radial force level, the machine control system operates the respective workpiece spindle at standstill with regard to its rotary motion.

36. Multi-spindle lathe according to claim 29, wherein, during the indexing of the spindle drum, the machine control system adapts the rotary speed of the workpiece spindles to the rotary speed required in the next spindle station.

37. Multi-spindle lathe according to claim 1, wherein associated with each spindle station is at least one tool carrier, by means of which a tool held thereby is movable both in the X-direction transversely to the respective workpiece spindle axis and also in the Z-direction parallel to the respective workpiece spindle axis.

38. Multi-spindle lathe according to claim 1, wherein the workpiece guide bushing is displaceable by means of the respective tool carrier in the direction parallel to the workpiece spindle axis.

39. Multi-spindle lathe according to claim 38, wherein in the case of a plurality of tool carriers, one of the tool carriers is provided to displace the workpiece guide bushing, whilst at least one further tool carrier is or are controlled and moved by means of a machine control system following the one tool carrier.

40. Multi-spindle lathe according to claim 37, wherein the tool carrier is provided with a first driver element for displacing the respective workpiece guide bushing.

41. Multi-spindle lathe according to claim 40, wherein the workpiece guide bushing has a second driver element cooperating with the first driver element.

42. Multi-spindle lathe according to claim 41, wherein the driver elements are bringable, through movement of the tool carrier in the X-direction transversely to the workpiece spindle axis, into or out of operative connection.

43. Multi-spindle lathe according to claim 1, wherein a displacing device is associated with one spindle station, with which displacing device the workpiece guide bushing situated therein is displaceable.

44. Multi-spindle lathe according to claim 43, wherein the displacing device comprises a displacing cylinder and a displacing arm, and in that the workpiece guide bushing is displaceable with the displacing arm.

45. Multi-spindle lathe according to claim 43, wherein with the displacing device, a displacement of the workpiece guide bushing away from the respective workpiece spindle head takes place.

46. Method for operating a multi-spindle lathe comprising a machine frame, a spindle drum mounted on the machine frame so as to be rotatable about a spindle drum axis, workpiece spindles each arranged in a spindle position on the spindle drum and each mounted to be rotatable relative to the spindle drum about a workpiece spindle axis, said workpiece spindles being positionable, for machining workpieces arranged in said workpiece spindles, by rotating the spindle drum about the spindle drum axis into different spindle stations which are arranged statically relative to the machine frame, associated with each workpiece spindle is a workpiece guide bushing which is displaced, during the machining of a material bar as the workpiece, in the direction of the workpiece spindle axis, and in each of the workpiece guide bushings, the material bar is guided coaxially with the workpiece spindle axis through a guide sleeve which can freely rotate relative to an external housing of the respective workpiece guide bushing.

47. Method according to claim 46, wherein the workpiece guide bushings act upon the material bar by means of the guide sleeve with a varying radial force.

48. Method according to claim 46, wherein in the guide sleeve which is rotatable coaxially with the workpiece spindle axis, the material bar is guided through guide jaws that are placeable thereon.

49. Method according to claim 48, wherein, in each workpiece guide bushing, the guide jaws are displaced radially to a guidance axis of the guide sleeve.

50. Method according to claim 49, wherein the workpiece guide bushings act by means of the guide jaws with the radial force on the material bar.

51. Method according to claim 46, wherein, a medium is fed to each workpiece guide bushing for radially displacing the guide jaws.

52. Method according to claim 46, wherein by means of a control unit in the respective workpiece guide bushing, the radial force acting on the material bar for guidance thereof is adjusted.

53. Method according to claim 46, wherein in the workpiece guide bushings, the radial force with which they act upon the material bar for guidance thereof is controlled in a process-dependent manner.

54. Method according to claim 46, wherein the workpiece guide bushings can be fixed by controlling the radial force against a movement relative to the material bar in the direction parallel to the respective workpiece spindle axis.

55. Method according to claim 46, wherein by means of the control unit, the respective radial force is set to a releasing radial force level at which the material bar is freely movable, and in particular is freely rotatable, relative to the guide sleeve.

56. Method according to claim 46, wherein by means of the control unit, the respective radial force is set to a guiding radial force level at which the material bar can be displaced relative to the workpiece guide bushing in a direction parallel to the respective workpiece spindle axis, although the guide sleeve is co-rotated by the material bar due to the friction provided by the guiding radial force level.

57. Method according to claim 46, wherein by means of the control unit, the respective radial force is set to a clamping radial force level at which the material bar can neither be displaced relative to the guide sleeve parallel to the respective workpiece spindle axis nor rotated relative to the guide sleeve.

58. Method according to claim 46, wherein by means of a machine control system, a control of the workpiece guide bushings is provided, which on indexing the spindle drum, fixes the workpiece guide bushings relative to the material bar by increasing the radial force of the guide jaws against a movement in the direction parallel to the respective workpiece spindle axis and after ending of the indexing of the spindle drum, reduces the radial force far enough that for long turning, a displacement of the workpiece guide bushing relative to the material bar with simultaneous precise support and guidance thereof transversely to the workpiece spindle axis is possible.

59. Method according to claim 55, wherein the machine control system changes the rotary speed of the respective workpiece spindle only in the presence of the clamping radial force level.

60. Method according to claim 55, wherein, in the presence of the guiding radial force level, the machine control system leaves the rotary speed of the respective workpiece spindle unchanged.

61. Method according to claim 46, wherein, in the presence of the releasing radial force level, the respective workpiece spindle is operated by the machine control system at standstill with regard to its rotary motion.

62. Method according to claim 55, wherein during the indexing of the spindle drum, the machine control system adapts the rotary speed of the workpiece spindles to the rotary speed required in the next spindle station.

63. Method for operating a multi-spindle lathe according to the preamble of claim 46 or according to claim 46, wherein associated with each workpiece spindle is a workpiece guide bushing for guidance of a material bar which is held in the workpiece spindle for long turning, and is displaced relative to the respective workpiece spindle in a direction parallel to the workpiece spindle axis during long turning.

64. Method according to claim 63, wherein associated with each spindle station is at least one tool carrier, by means of which a tool held thereby is moved both in the X-direction transversely to the respective workpiece spindle axis and also in the Z-direction parallel to the respective workpiece spindle axis.

65. Method according to claim 63, wherein the workpiece guide bushing is displaced by the respective tool carrier in a direction parallel to the respective workpiece spindle axis.

66. Method according to claim 65, wherein in the case of a plurality of tool carriers, the workpiece guide bushing is displaced by one of the tool carriers, whilst at least one further tool carrier is moved by means of a machine control system following the one tool carrier.

67. Method according to claim 65, wherein the respective workpiece guide bushing is displaced by a first driver element arranged on the tool carrier.

68. Method according to claim 67, wherein the workpiece guide bushing is moved by a second driver element cooperating with the first driver element.

69. Method according to claim 67, wherein the driver element is brought, through a movement of the tool carrier in the X-direction transversely to the workpiece spindle axis, into or out of operative connection.
